(19) United States
(12) Patent Application Publication
(10) Pub. No.: US 2024/0379007 A1
(43) Pub. Date: Nov. 14, 2024

(54) VEHICLE TRAVEL MONITORING SYSTEM, TRAVEL MONITORING METHOD, AND TRAVEL MONITORING PROGRAM

(71) Applicant: Yamaha Hatsudoki Kabushiki Kaisha, Shizuoka (JP)

(72) Inventor: Kento KON, Shizuoka (JP)

(21) Appl. No.: 18/691,442

(22) PCT Filed: Jul. 29, 2022
(86) PCT No.: PCT/JP2022/029306

§ 371 Date: Mar. 12, 2024

(30) Foreign Application Priority Data
Sep. 13, 2021 (JP) 2021-148791

(51) Int. Cl. G08G 1/00; G08G 1/052; G08G 1/056; G09G 3/20

(52) U.S. Cl. CPC G08G 1/20; G08G 1/052; G08G 1/056; G09G 3/2096; G09G 2340/045; G09G 2340/0464; G09G 2354/00; G09G 2370/025; G09G 2380/10

(57) ABSTRACT

A layout of areas to display travel data is easily changed in a monitoring screen so as to effectively use the monitoring screen having a limited area. A travel monitoring system includes a monitoring device that controls a display unit to display a monitoring screen indicating a plurality of travel data items of a first vehicle. The monitoring device reserves a plurality of large-sized areas and a plurality of small-sized areas in the monitoring screen. A travel data item (e.g., vehicle speed) is displayed in the large-sized area. A travel data item or a guidance (mark) indicating a type of the travel data is displayed in the small-sized area. A size of the large-sized area in one of a horizontal direction and a vertical direction is a positive integer multiple of a size of the small-sized area.

### TECHNICAL FIELD

The present disclosure relates to a travel monitoring system, a travel monitoring method, and a travel monitoring program for monitoring travel of a vehicle.

### BACKGROUND ART

JP2017-041018A discloses a system for managing the use of company vehicles. In this system, a company vehicle sends information, such as a current position of the vehicle, a travel distance, a vehicle speed, and a remaining amount of fuel, to the management server. Such information is sent from the management server to the terminal (personal computer or portable terminal) of the administrator.

### SUMMARY OF INVENTION

### Technical Problem

In recent years, self-driving vehicles have been actively developed. Some self-driving vehicles are used by visitors in specific areas, such as tourist spots. A system for remotely monitoring self-driving vehicles used in a specific area has also been studied. In the monitoring system, it is desirable that a monitoring person can instantly grasp conditions of the vehicle, and when an abnormality occurs, the monitoring person can immediately access information necessary to address the abnormality. In this regard, the information indicating conditions of the vehicle covers not only the vehicle speed and the current position of the vehicle but also various types of data, such as the angle of the steering wheel, the acceleration, and the temperature of the acceleration sensor (Inertial Measurement Unit (IMU)). As such, a limited area of a monitoring screen needs to be effectively used in order to display such a wide range of information.

### Solution to Problem

(1) A travel monitoring system proposed in the present disclosure includes a communication unit that receives a plurality of travel data items of a first vehicle and a control unit that controls a display device to display a monitoring screen indicating the plurality of travel data items. The control unit reserves a plurality of first sized areas and a plurality of second sized areas in the monitoring screen. The control unit displays a first travel data item in one of the plurality of first sized areas, the first travel data item being one of the plurality of travel data items, and displays a second travel data item or a guidance indicating a type of the second travel data item in one of the plurality of second sized areas, the second travel data item being another one of the plurality of travel data items. Each of the plurality of first sized areas has a first size in a first direction, which is one of a vertical direction and a horizontal direction, and has a second size in a second direction, which is the other of the vertical direction and the horizontal direction. Each of the plurality of second sized areas has a third size in the first direction and has a fourth size in the second direction. The first size corresponds to an integer multiple of the third size, where the integer is greater than one. The first sized area and the second sized area are defined in this manner, which serves to easily change a layout of the first sized area and the second sized area in the monitoring screen. This facilitates effectively using the monitoring screen having a limited area.
(2) In the travel monitoring system according to (1), the second size corresponds to an integer multiple of the fourth size, where the integer is greater than one. This further serves to easily change a layout of the first sized area and the second sized area in the monitoring screen. This further facilitates effectively using the monitoring screen having a limited area.
(3) In the travel monitoring system according to (1), the second size may correspond to the fourth size. This further serves to easily change a layout of the first sized area and the second sized area in the monitoring screen. This further facilitates effectively using the monitoring screen having a limited area.
(4) In the travel monitoring system according to (3), the first direction may be a vertical direction, and the second direction may be a horizontal direction.
(5) In the travel monitoring system according to (3), the first direction may be a horizontal direction, and the second direction may be a vertical direction.
(6) In the travel monitoring system according to (1), the control unit reserves the plurality of first sized areas, the plurality of second sized areas, and a plurality of third sized areas in the monitoring screen. Each of the plurality of third sized areas has a fifth size in the first direction and a sixth size in the second direction. The third size corresponds to an integer multiple of the fifth size and/or the fourth size corresponds to an integer multiple of the sixth size, where the integer is greater than one. This further facilitates effectively using the monitoring screen having a limited area.
(7) In the travel monitoring system according to (1), the control unit may display text and a graphic relating to the first travel data item in the one of the plurality of first sized areas. The control unit may display only one of the text and the graphic relating to the guidance in the one of the second sized areas, the guidance representing the second travel data item or a type of the second travel data item. This further facilitates effectively using the monitoring screen having a limited area.
(8) In the traveling monitoring system according to (1), the control unit reserves a first vehicle travel data area and a second vehicle travel data area in the monitoring screen, where the plurality of travel data items of the first vehicle are displayed in the first vehicle travel data area and the plurality of travel data items of the second vehicle are displayed in the second vehicle travel data area. Each of the first vehicle travel data area and the second vehicle travel data area may include the plurality of first sized areas and the plurality of second sized areas. This system enables to simultaneously monitor a plurality of vehicles.
(9) In the travel monitoring system according to (8), the control unit may change relative positions of the plurality of first sized areas and the plurality of second sized areas in each of the first vehicle travel data area and the second vehicle travel data area in accordance with a layout change instruction. This enables simplifying the work of changing the layout of the first sized area and the second sized area in the plurality of vehicle travel data areas.
(10) In the travel monitoring system according to (8), the control unit determines whether a travel condition of the first vehicle satisfies a predetermined condition based on the plurality of travel data items, and, if the first vehicle satisfies the predetermined condition, relatively enlarges the first vehicle travel data area. This allows a monitoring person to appropriately recognize a case when an abnormality occurs in the travel condition of the first vehicle. In a case where the first vehicle satisfies the predetermined condition, the first vehicle travel data area may be enlarged from the original size. Alternatively, the second vehicle travel data area may be reduced from the original size and the first vehicle travel data area may be relatively enlarged.
(11) In the travel monitoring system according to (8), the control unit may obtain a layout change instruction and change the layout of the plurality of first sized areas and the plurality of second sized areas in the monitoring screen based on the layout change instruction. This enables changing the layout of the first sized area and the second sized area in the monitoring screen in accordance with the needs of the monitoring person.
(12) In the travel monitoring system according to (10), the layout change instruction includes information on a size and a position of an area in which each travel data item is displayed.
(13) In the travel monitoring system according to (1), the control unit may display the first travel data item in the one of the plurality of first sized areas in a first display condition, and display the first travel data item in one of the plurality of second sized areas in a second display condition. This allows the first travel data item to be displayed in both the first sized area and the second sized area, thereby increasing flexibility of a layout in the monitoring screen.
(14) In the travel monitoring system according to (1), the control unit determines whether a travel condition of the first vehicle satisfies a predetermined condition, and if the travel condition of the first vehicle satisfies the predetermined condition, changes a layout of the plurality of first sized areas and the plurality of second sized areas. This configuration helps appropriately present the travel data related to the abnormality to the monitoring person when an abnormality occurs in the vehicle.
(15) In the travel monitoring system according to (1), the control unit may reserve at least one of the plurality of second sized areas in an area having a size corresponding to the first sized area. The control unit may reserve an adjustment area in the area in which the at least one of the second sized areas is reserved, where the adjustment area is an area in which the plurality of travel data items are not displayed. The use of the adjustment area serves to easily change a layout of the first sized area and the second sized area in the monitoring screen.
(16) In the travel monitoring system according to (1), the control unit may display an input unit that has a size corresponding to the first sized area or the second sized area and receives an operation of a monitoring person. Upon detecting an operation on the input unit, the control unit may transmit a command according to the operation, to the first vehicle.
(17) A travel monitoring method of a vehicle proposed in the present disclosure includes receiving a plurality of travel data items of a first vehicle and controlling a display device to display a monitoring screen indicating the plurality of travel data items. A first travel data item is displayed in one of the plurality of first sized areas, the first travel data item being one of the plurality of travel data items, and a second travel data item or a guidance indicating a type of the second travel data item is displayed in one of the plurality of second sized areas, the second travel data item being another one of the plurality of travel data items. Each of the plurality of first sized areas has a first size in a first direction, which is one of a vertical direction and a horizontal direction, and has a second size in a second direction, which is the other of the vertical direction and the horizontal direction. Each of the plurality of second sized areas has a third size in the first direction and has a fourth size in the second direction. The first size corresponds to an integer multiple of the third size, where the integer is greater than one. The first sized area and the second sized area are defined in this manner, which serves to easily change a layout of the first sized area and the second sized area in the monitoring screen. This facilitates effectively using the monitoring screen having a limited area.
(18) A travel monitoring program of a vehicle proposed in the present disclosure causes a computer to function as a communication unit that receives a plurality of travel data items of a first vehicle, and a control unit that controls a display device to display a monitoring screen indicating the plurality of travel data items. The control unit reserves a plurality of first sized areas and a plurality of second sized areas in the monitoring screen. The control unit displays a first travel data item in one of the plurality of first sized areas, the first travel data item being one of the plurality of travel data items, and displays a second travel data item or a guidance indicating a type of the second travel data item in one of the plurality of second sized areas, the second travel data item being another one of the plurality of travel data items. Each of the plurality of first sized areas has a first size in a first direction, which is one of a vertical direction and a horizontal direction, and has a second size in a second direction, which is the other of the vertical direction and the horizontal direction. Each of the plurality of second sized areas has a third size in the first direction and has a fourth size in the second direction. The first size corresponds to an integer multiple of the third size, where the integer is greater than one. The first sized area and the second sized area are defined in this manner, which serves to easily change a layout of the first sized area and the second sized area in the monitoring screen. This facilitates effectively using the monitoring screen which has a limited area.

### BRIEF DESCRIPTION OF THE DRAWINGS

FIG. 1 is a diagram illustrating an example of a vehicle travel monitoring system proposed in the present disclosure;

FIG. 2 is a block diagram showing a structure of a self-driving vehicle;

FIG. 3 is a diagram illustrating an example of a monitoring screen displayed on a display unit of a monitoring terminal;

FIG. 4 is a diagram illustrating an example of a travel data area constituting the monitoring screen;

FIG. 5A is a diagram illustrating a large-sized area, a medium-sized area, and a small-sized area defined in the travel data area;

FIG. 5B is an enlarged diagram of FIG. 5A illustrating a large-sized area, a medium-sized area, and a small-sized area defined in the travel data area;

FIG. 6 is a diagram illustrating an example of the monitoring screen displayed when an abnormality occurs in a first vehicle;

FIG. 7 is a block diagram showing functions of a control unit of the monitoring device;

FIG. 8A is a diagram showing an example of a layout change instruction table;

FIG. 8B is a diagram showing an example of a display format instruction table;

FIG. 9 is a flow chart showing an example of processing executed by a screen layout control unit shown in FIG. 7;

FIG. 10 is a diagram showing an example of the layout definition table;

FIG. 11A is a diagram showing an example of a table defining sizes of the large-sized area, the medium-sized area, and the small-sized area;

FIG. 11B is a diagram showing an example of a table defining positions of the large-sized area, the medium-sized area, and the small-sized area in the travel data area;

FIG. 12 is a block diagram showing functions of a control unit of a monitoring terminal; and

FIG. 13 is a sequence diagram showing processing executed in the monitoring terminal, the monitoring device, and the vehicle.

### DESCRIPTION OF EMBODIMENTS

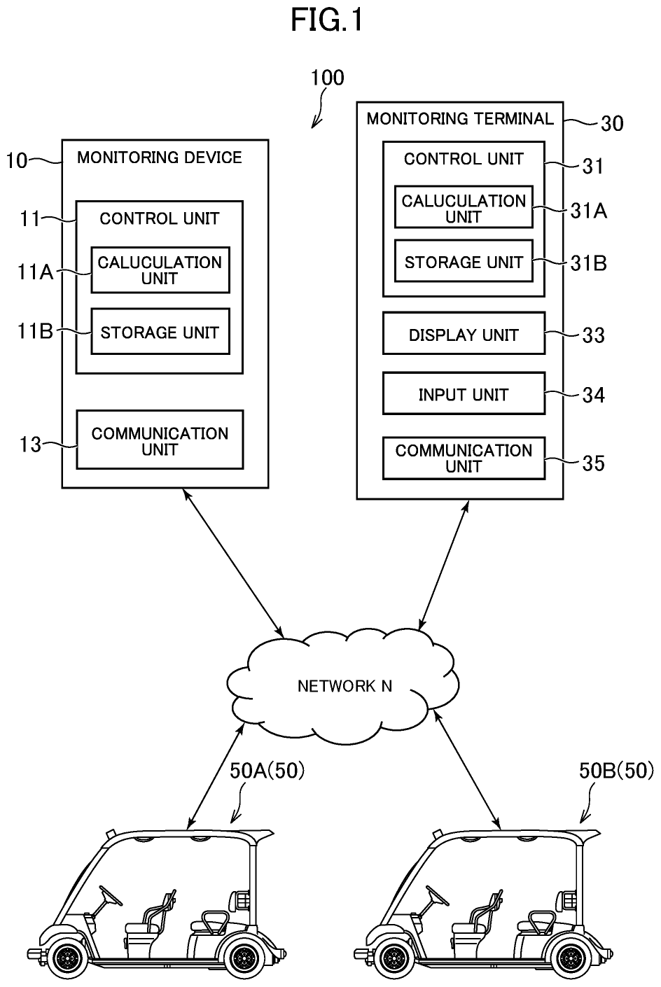

In the following, an example of a vehicle travel monitoring system proposed in the present disclosure will be described. FIG. 1 is a diagram illustrating a travel monitoring system 100, which is an example of the travel monitoring system proposed in the present disclosure.

### [System Hardware]

As shown in FIG. 1, the travel monitoring system 100 includes a monitoring device 10 that receives travel data (e.g., current vehicle speed, current position) from a plurality of self-driving vehicles 50A and 50B and a monitoring terminal 30 that receives the travel data from the monitoring device 10 and presents the travel data to a monitoring person. The monitoring device 10 is connected to the self-driving vehicles 50A and 50B via a network N. The monitoring device 10 and the monitoring terminal 30 are also connected to each other via the network N. The network N may include the Internet or a local area network (LAN). The travel monitoring system 100 and the vehicles 50A and 50B monitored by the travel monitoring system 100 constitute the self-driving system. In the following, a reference numeral 50 is used for two vehicles 50A and 50B when these vehicles are not distinguished.

The travel monitoring system 100 may not include the monitoring terminal 30. In this case, the travel data received from the self-driving vehicle 50 is displayed on a display unit of the monitoring device 10, and the monitoring person may monitor the travel of the vehicle 50 through the monitoring device 10.

The travel monitoring system 100 may include a plurality of monitoring terminals 30. In this case, one or more vehicles 50, for which the travel data is displayed on a first monitoring terminal 30, may be different from one or more vehicles 50, for which the travel data is displayed on a second monitoring terminal 30.

The vehicle 50 need not necessarily be a self-driving vehicle. That is, the travel monitoring system 100 may monitor a vehicle manually operated by a driver. The number of vehicles monitored by the travel monitoring system 100 is not limited to two, and may be one, or three or more.

### [Monitoring Device]

The monitoring device 10 includes a server computer, for example. As shown in FIG. 1, the monitoring device 10 includes a control unit 11 and a communication unit 13. The control unit 11 includes a calculation unit 11A and a storage unit 11B. The calculation unit 11A has a CPU (central processing unit). The storage unit 11B includes a RAM (random access memory), a ROM (read only memory), an HDD (hard disc drive), and an SSD (solid state drive), for example. The control unit 11 causes the calculation unit 11A to execute a program stored in the storage unit 11B and executes the processing for monitoring the vehicle 50. The storage unit 11B may store the travel data received from the vehicle 50. The processing executed by the control unit 11 will be described in detail later. The communication unit 13 is a communication module for performing two-way communication with the vehicle 50 and the monitoring terminal 30 via the network N. The communication unit 13 may be a wireless LAN adapter or a wired LAN adapter.

### [Monitoring Terminal]

The monitoring terminal 30 is a personal computer, a smartphone, and a tablet computer, for example. As shown in FIG. 1, the monitoring terminal 30 includes a control unit 31, a display unit 33, an input unit 34, and a communication unit 35.

The control unit 31 includes a calculation unit 31A and a storage unit 31B. The calculation unit 31A has a CPU. The storage unit 31B includes a RAM, a ROM, an HDD, and an SSD, for example. The control unit 31 causes the calculation unit 31A to execute a program stored in the storage unit 31B and executes the processing for monitoring the vehicle 50. The processing executed by the control unit 31 will also be described in detail later.

The display unit 33 is a display that displays travel information provided from the monitoring device 10. For example, a liquid crystal display and an organic EL display can be used as the display unit 33.

The input unit 34 is a device for inputting an instruction of the monitoring person to the control unit 31. For example, a keyboard, a mouse pointer, and a touch sensor provided in the display unit 33 can be used as the input unit 34.

The communication unit 35 is a communication module for performing two-way communication with the monitoring terminal 30 via the network N. The communication unit 35 may be a wireless LAN adapter or a wired LAN adapter.

### [Vehicle]

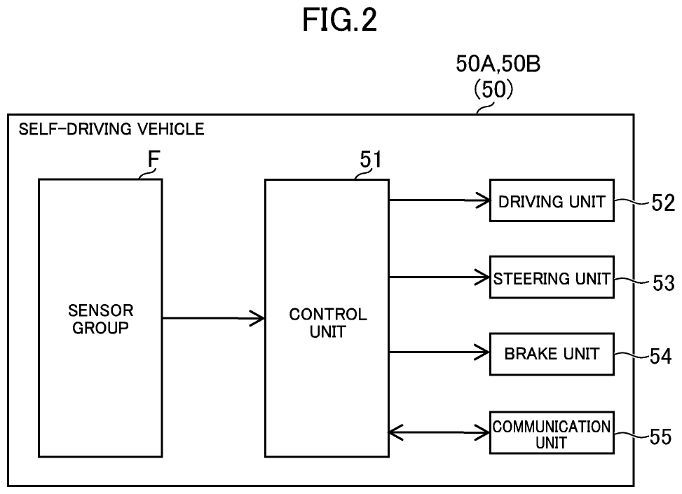

As shown in FIG. 2, the self-driving vehicle 50 includes a control unit 51, a driving unit 52, a steering unit 53, a brake unit 54, a communication unit 55, and a sensor group F.

The driving unit 52 includes an electric motor that drives the wheels of the vehicle 50, a drive circuit (e.g., inverter circuit) that supplies electric power to the electric motor, and a battery, for example. The driving device supplies the electric power of the battery to the electric motor in accordance with a command from the control unit 51. The driving source of the vehicle 50 is not limited to the electric motor, and may be an engine, for example.

The steering unit 53 includes a steering device, an actuator (steering motor) that moves the steering device, and a drive circuit that supplies electric power to the actuator, for example. The drive circuit supplies the power of the battery to the actuator in accordance with a command from the control unit 51.

The brake unit 54 includes a brake device, an actuator that moves the brake device, and a drive circuit that supplies electric power to the actuator, for example. The drive circuit supplies the power of the battery to the actuator in accordance with a command from the control unit 51.

The sensor group F includes sensors, devices, and circuits for outputting a signal related to the travel and the condition of the vehicle. For example, the sensor group F includes a vehicle speed sensor that outputs a signal corresponding to the vehicle speed, an IMU (inertial measurement unit) that outputs a signal corresponding to acceleration or angular velocity acting on the vehicle 50, a temperature sensor that measures temperature of the IMU, a circuit that measures a current of the battery, a GNSS (global navigation satellite system) receiver, and a LiDAR (light detection and ranging) sensor. The sensors included in the sensor group F are not limited to the example described here.

The control unit 51 controls the driving unit 52, the steering unit 53, and the brake unit 54 so that the vehicle 50 travels in accordance with a travel plan determined by a user of the vehicle 50 or an operator of the vehicle 50.

The control unit 51 may have a self-driving mode, in which the driving unit 52 and other units are controlled in accordance with a travel plan for traveling without the need of an operation of the driver, and a manual driving mode, in which the driving unit 52 and other units are controlled in accordance with an operation (accelerator operation or steering operation) by the driver. The driving mode may also be one of the travel data items.

The communication unit 55 transmits various types of data (travel data) related to the travel of the vehicle 50 to the monitoring device 10. The communication unit 55 is a wireless device that enables bidirectional wireless communication with the monitoring device 10, for example.

### [System Overview]

Each vehicle 50 transmits travel data to the monitoring device 10. The travel data includes, for example, a vehicle speed, a travel direction (forward/backward), current position data of the vehicle 50, and a travel distance, which are information calculated based on output of the sensor or the device mounted on the vehicle 50 or the output of the sensor or the device. Further, the travel data may indicate a condition of a sensor or a device mounted on the vehicle 50. For example, the travel data may include a temperature of the sensor and an operation mode of the device. The vehicle 50 transmits the travel data to the monitoring device 10 at predetermined time intervals. The monitoring device 10 transmits the travel data to the monitoring terminal 30, and displays a monitoring screen including the travel data on the display unit 33.

The monitoring device 10 and the monitoring terminal 30 may be capable of communicating with each other according to HTTP (hyper text transfer protocol), for example. In this case, the monitoring terminal 30 uses browser software to receive information for controlling the monitoring screen and travel data from the monitoring device 10. In the following, the information for controlling the monitoring screen is referred to as “monitoring screen control information”. The monitoring screen control information is written in HTML, CSS, and JavaScript, for example. The monitoring terminal 30 uses the browser software to display the monitoring screen according to the monitoring screen control information on the display unit 33. Alternatively, dedicated software for forming the monitoring screen may be installed in the monitoring terminal 30. In this case, the monitoring terminal 30 may display the monitoring screen on the display unit 33 through the functions of the software.

### [Monitor Screen]

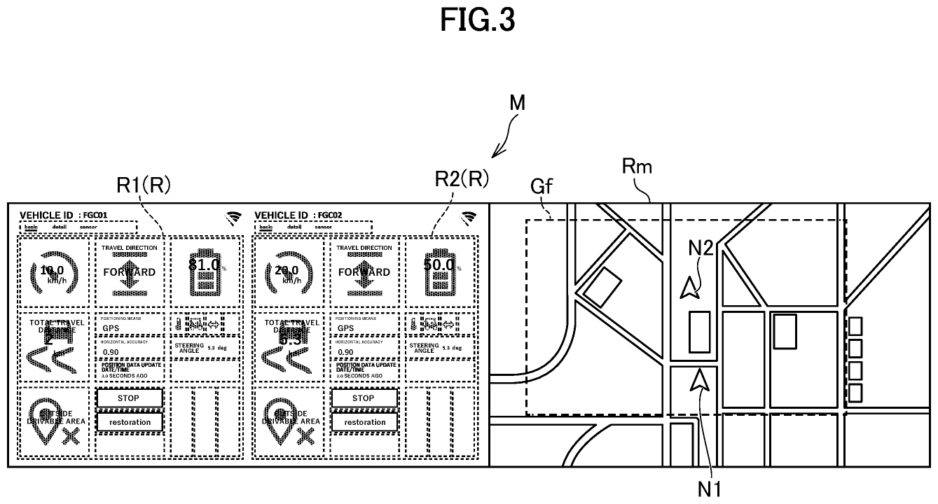

FIG. 3 is a diagram illustrating an example of the monitoring screen. The monitoring screen M shown in FIG. 3 has travel data areas R1 and R2 for displaying the travel data of the vehicle 50. In a case where the travel monitoring system 100 monitors a plurality of vehicles 50 (50A and 50B), the monitoring screen M may include travel data areas R1 and R2 for each of the vehicles 50. For example, the monitoring screen M includes a first vehicle travel data area R1 for displaying the travel data of a first vehicle 50A, and a second vehicle travel data area R2 for displaying the travel data of a second vehicle 50B. The travel data areas R1 and R2 may be arranged in the horizontal direction as shown in FIG. 3, or in the vertical direction. The travel data displayed simultaneously in the travel data areas R1 and R2 may be a part of the travel data received from the vehicle 50 (e.g., important travel data for the monitoring person).

As shown in FIG. 3, the monitoring screen M may include a map area Rm. For example, the map area Rm displays a map and marks N1 and N2 indicating the current positions of the vehicles 50. In a case where the travel monitoring system 100 monitors a plurality of vehicles 50 (50A and 50B), one map area Rm may display the marks N1 and N2 indicating the current positions of respective vehicle 50A and 50B. The travel data areas R1 and R2 and the map area Rm may be arranged in the horizontal direction as shown in FIG. 3, or in the vertical direction. As shown in FIG. 3, the map area Rm may indicate a drivable area Gf. In the example shown in FIG. 3, the drivable area Gf is indicated by a broken line. The “drivable area” is, for example, an area in which self-driving is permitted, and is determined in advance by the operator of the vehicles 50A and 50B. The “drivable area” is, for example, a tourist area in which the vehicles 50A and 50B are used.

### [Travel Data Area]

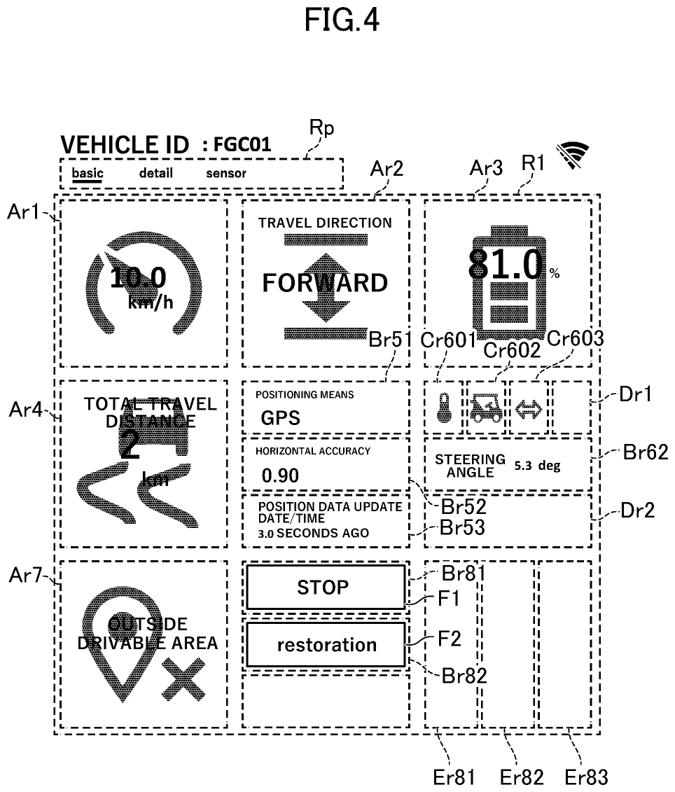

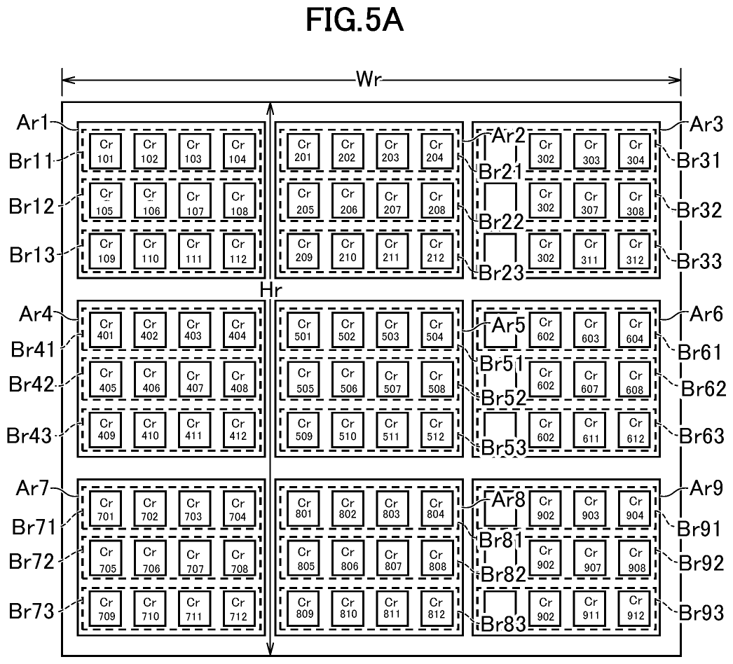

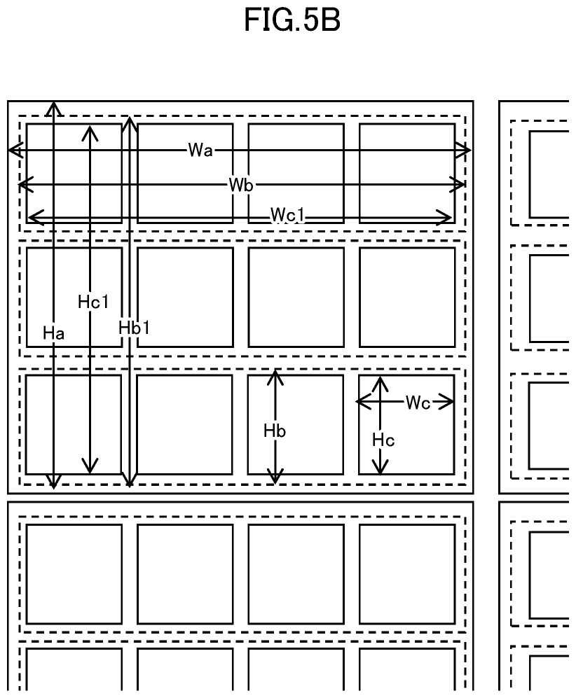

FIG. 4 is a diagram illustrating an example of the travel data area R1 displaying travel data of the first vehicle 50A. FIG. 5A is a diagram for explaining the travel data areas R1 and R2, and FIG. 5B is an enlarged view of FIG. 5A. The travel data area R1 for displaying the travel data of the first vehicle 50A and the travel data area R2 for displaying the travel data of the second vehicle 50B may have the same layout.

As shown in FIG. 4, a plurality of large-sized areas Ar1, Ar2, . . . a plurality of medium-sized areas Br51, Br52, . . . and a plurality of small-sized areas Cr601, Cr602, . . . are defined in the travel data area R1. Each area displays the travel data and/or a guidance (mark) indicating the type of the travel data.

In the following, if a plurality of large-sized areas Ar1, Ar2, . . . are not distinguished, a sign “Ar” is used for a large-sized area. If a plurality of medium-sized areas Br11, Br12, . . . (see FIG. 5A) are not distinguished, a sign “Br” is used for a medium-sized area. Further, if a plurality of small-sized areas Cr101, Cr102, . . . (see FIG. 5A) are not distinguished, a sign “Cr” is used for a small-sized area.

### [Large-Sized Area]

The large-sized areas Ar each indicate a plurality of travel data items. For example, in the example shown in FIG. 4, the vehicle speed is indicated in the large-sized area Ar1, and the travel direction of the vehicle is indicated in the adjacent large-sized area Ar2.

The large-sized area Ar displays text and graphics related to the travel data. The text is a numerical value or a word representing the travel data. The graphic is a mark indicating the type of travel data, for example. In the following, this mark is referred to as a “type mark.”

As shown in FIG. 4, for example, the large-sized area Ar1 on the upper left displays the vehicle speed “10.0 km/h” and the type mark corresponding to the vehicle speed. The adjacent large-sized area Ar2 displays “forward”, which is a travel direction of the vehicle 50A, and an arrow mark in the front-rear direction is shown as a type mark. The large-sized area Ar3 on the upper right indicates the remaining battery power of “81.0%” and the type mark corresponding to the remaining battery power. The large-sized area Ar4 in the middle section indicates the total travel distance “2 km” of the vehicle 50A and the graphic of the traveling vehicle. The large-sized area Ar7 on the lower left displays a warning “outside drivable area” when the vehicle 50A is out of the drivable area Gf (see FIG. 3) and a type mark corresponding to such a warning. The warning “outside drivable area” may be turned off when the vehicle 50A is traveling in the drivable area Gf, and turned on when going outside of the drivable area Gf, or the color may be changed when going outside of the drivable area Gf.

### [Medium-Sized Area]

The medium-sized areas also each indicate a plurality of travel data items. The text is displayed in the medium-sized area Br. The text is a numerical value or a word representing the travel data. Unlike the large-sized area Ar, the type mark is not displayed in the medium-sized area Br.

As shown in FIG. 4, for example, the medium-sized area Br51 in the middle section indicates “GPS” as the means for measuring the current position, the medium-sized area Br52 indicates “0.9” as the accuracy of the current position of the vehicle 50A indicated by the map area Rm, and the medium-sized area Br53 indicates “3.0 seconds ago” as the updated date and time of the current position displayed in the map area Rm. The monitoring person refers to the updated date and time, thereby determining whether the position of the vehicles 50 displayed in the map-area Rm is appropriate. The medium-sized area Br62 indicates “5.3 deg” as the steering angle (direction of the front wheel).

### [Small-Sized Area]

The small-sized area Cr displays a guidance indicating a type of travel data. The “guidance” is, for example, a mark indicating a type.

Such a mark may have a reduced size of the type mark displayed in the large-sized area Ar, for example. Unlike the large-sized area Ar and the medium-sized area Br, the text indicating the travel data is not displayed in the small-sized area Cr.

As shown in FIG. 4, for example, the small-sized area Cr601 indicates a type mark corresponding to the temperature of 50A of the IMU, which is one of the sensors mounted on the vehicle (thermometer mark), the small-sized area Cr602 therebelow indicates a type mark corresponding to the driving mode (self-driving mode/manual driving mode) of the vehicle (vehicle graphic), and the small-sized area Cr603 shows a type mark corresponding to the operating condition of a flasher indicating the turn direction of the vehicle (arrow mark).

When the monitoring person operates the input unit 34 (see FIG. 1) to select the small-sized areas Cr601, Cr602, and Cr603, for example, the travel data (text) corresponding to the small-sized areas Cr601, Cr602, and Cr603 may be displayed. For example, when the monitoring person selects the small-sized area Cr601, the temperature of the IMU may be displayed.

As described above, the large-sized area Ar displays the text and the graphic (type mark) related to the travel data. In this manner, the monitoring person can easily recognize what the information (numerical value and word) displayed in the large-sized area Ar indicates. In the medium-sized area Br, only the text related to the travel data is displayed. In the small-sized area Cr, only the graphic (type mark) related to the travel data is displayed. As such, the information displayable on the travel data area R1 can be increased, and the limited area of the monitoring screen M can be effectively used.

### [Selection of Travel Data Area]

The display of travel data areas R1 and R2 may be selectable from a plurality of options. In the example shown in FIG. 4, the monitoring screen M includes a layout selecting area Rp above the travel data area R1. The layout selecting area Rp shows “basic”, “detail 1”, and “detail 2” as options for the display layout. For example, the layout of the travel data and the areas Ar, Br, and Cr displayed when “basic” is selected may be different from the layout of the travel data and the areas Ar, Br, and Cr displayed when “detail 1” or “detail 2” is selected.

FIG. 4 shows the travel data area R1 when “basic” is selected. When “detail 1” or “detail 2” is selected, more detailed travel data or more travel data items may be displayed than “basic”.

The one or more travel data items may be displayed in any of “basic” and “detail 1” states. For example, when “basic” is selected, the travel data may be displayed in the large-sized area Ar, and when “detail 1” is selected, the travel data may be displayed in the medium-sized area Br or the small-sized area Cr. For example, when “basic” is selected, the vehicle speed may be displayed in the large-sized area Ar together with the type mark, and when “detail 1” is selected, the vehicle speed may be displayed in the medium-sized area Br only by text. This enables displaying more travel data items in the state of “detail 1” on the monitoring screen M than in the state of “basic.”

### [Size of Each Area]

Referring to FIG. 5B, sizes of three types of areas Ar, Br, and Cr will be described in detail.

### [Relationship Between Large-Sized Area and Small-Sized Area]

The size of the large-sized area Ar in the vertical direction (Ha, see FIG. 5B) corresponds to an integer (m) multiple of the size of the small-sized area Cr (Hc, see FIG. 5B) in the vertical direction (m>1). In the example shown in FIG. 5B, the size (Ha) of the large-sized area Ar in the vertical direction corresponds to three times the size of the small-sized area Cr (Hc, see FIG. 5A) in the vertical direction. The size of the large-sized area Ar (Wa, see FIG. 5A) in the horizontal direction corresponds to an integer (n) multiple of the size (Wc, see FIG. 5A) of the small-sized area Cr in the horizontal direction (n>1). In the example shown in FIG. 5B, the size (Wa) of the large-sized area Ar in the horizontal direction corresponds to four times the size (Wc) of the small-sized area Cr in the horizontal direction. As shown in FIG. 5A, in each large-sized area Ar, n (specifically, four) small-sized areas Cr are defined in the horizontal direction, and m (specifically, three) small-sized areas Cr are defined in the vertical direction.

The large-sized area Ar and the small-sized area Cr are defined in this way, and this serves to easily change the layout of the large-sized area Ar and the small-sized area Cr in the monitoring screen. This enables easily and effectively using the monitoring screen M which has a limited area.

In the above, “the size (Ha) of the large-sized area Ar in the vertical direction” is “Hr/p” (p>1), where “p” is the number of large-sized areas Ar vertically aligned in the travel data area R1, and is three in FIGS. 5A and 5B. “Hr” is the size of the travel data area R1 in the vertical direction. Further, “the size (Wa) of the large-sized area Ar in the horizontal direction” is “Wr/q” (q>1), where “q” is the number of large-sized areas Ar arranged in the horizontal direction in the travel data area R1, and is three in FIGS. 5A and 5B. “Wr” is the size of the travel data area R1 in the horizontal direction.

In the above, “the size of the large-sized area Ar in the vertical direction (Ha) corresponds to an integer (m) multiple of the size of the small-sized area Cr (Hc) in the vertical direction (m>1)” means that the following two conditions are satisfied, for example. The first condition is that the size (Hc1, see FIG. 5B) of m (three in FIG. 5B) small-sized areas Cr arranged in the vertical direction is equal to or smaller than the size (Ha) of the large-sized area Ar in the vertical direction. The second condition is that when (m+1) small-sized areas Cr are arranged in the vertical direction, the size of the (m+1) small-sized areas Cr in the vertical direction is larger than the size (Ha) of the large-sized area Ar in the vertical direction.

Similarly, “the size (Wa) of the large-sized area Ar in the horizontal direction corresponds to an integer (n) multiple of the size (Wc) of the small-sized area Cr in the horizontal direction (n>1)” means that the first condition and the second condition described above are satisfied, for example. That is, the first condition is that the size Wc1 (see FIG. 5B) of n (four in FIG. 5B) small-sized areas Cr arranged in the horizontal direction is equal to or smaller than the size (Wa) of the large-sized area Ar in the horizontal direction. The second condition is that, when (n+1) small-sized areas Cr are arranged in the horizontal direction, the size of the (n+1) small-sized areas Cr in the horizontal direction is larger than the size (Wa) of the large-sized area Ar in the horizontal direction.

### [Relationship Between Large-Sized Area and Medium-Sized Area]

The size (Ha) of the large-sized area Ar in the vertical direction corresponds to an integer (e) multiple of the size (Hb, see FIG. 5B) of the medium-sized area Br in the vertical direction (e>1). In the example shown in FIG. 5B, the size (Ha) of the large-sized area Ar in the vertical direction corresponds to three times the size (Hb) of the medium-sized area Br in the vertical direction. On the other hand, the size (Wa) of the large-sized area Ar in the horizontal direction corresponds to the size (Wb, see FIG. 5B) of the medium-sized area Br in the horizontal direction. That is, the size (Wa) of the large-sized area Ar in the horizontal direction is substantially the same as the size (Wb) of the medium-sized area Br in the horizontal direction. As shown in FIG. 5A, in each large-sized area Ar, one medium-sized area Br is defined in the horizontal direction, and e (specifically, three) medium-sized areas Br are defined in the vertical direction. Unlike the example shown in FIG. 5A, the size (Ha) of the large-sized area Ar in the horizontal direction may correspond to an integer (f) multiple of the size (Hb) of the medium-sized area Br in the horizontal direction (f>1).

The large-sized area Ar and the medium-sized area Br are defined in this manner, which serves to easily change the layout of the large-sized area Ar and the medium-sized area Br in the monitoring screen. This facilitates effectively using the monitoring screen M having a limited area.

In the above, “the size (Ha) of the large-sized area Ar in the vertical direction” is “Hr/p” as described above. “The size (Wa) of the large-sized area Ar in the horizontal direction” is “Wr/q” as described above. In the above, “the size (Ha) of the large-sized area Ar in the vertical direction corresponds to an integer (e) multiple of the size (Hb) of the medium-sized area Br in the vertical direction (e>1)” may mean that the first condition and the second condition are satisfied, for example. That is, the first condition is that the size (Hb1, see FIG. 5B) of e (three in FIG. 5B) medium-sized areas Br arranged in the vertical direction is equal to or smaller than the size (Ha) of the large-size area Ar in the vertical direction. The second condition is that when (e+1) medium-sized areas Br are arranged in the vertical direction, the size of the (e+1) medium-sized areas Br in the vertical direction is larger than the size (Ha) of the large-sized area Ar in the vertical direction.

In the above, “the size (Wa) of the large-sized area Ar in the horizontal direction corresponds to the size (Wb) of the medium-sized area Br in the horizontal direction” means that the following two conditions are satisfied, for example. The first condition is that the size (Wa) of the large-sized area Are in the horizontal direction is equal to or smaller than the size (Wb) of the medium-sized area Br in the horizontal direction. The second condition is that the size (Wa) of the large-sized area Arv is less than twice the size (Wb) of the medium-sized area Br in the horizontal direction. Further, “the size (Ha) of the large-sized area Ar in the horizontal direction may correspond to an integer (f) multiple of the size (Hb) of the medium-sized area Br in the horizontal direction (f>1)” may mean that the first condition and the second condition are satisfied, for example. That is, the first condition is that the size of f medium-sized areas Br arranged in the horizontal direction is equal to or smaller than the size (Wa) of the large-sized area Ar in the horizontal direction. The second condition is that, when (f+1) medium-sized areas Br are arranged in the horizontal direction, the size of the (f+1) medium-sized areas Br in the horizontal direction is larger than the size (Wa) of the large-sized area Ar in the horizontal direction.

### [Relationship Between Medium-Sized Area and Small-Sized Area]

The size (Wb, see FIG. 5B) of the medium-sized area Br in the horizontal direction corresponds to an integer (g) multiple of the size (Wc) of the small-sized area Cr in the horizontal direction (g>1). In the example shown in FIG. 5B, the size (Wb) of the medium-sized area Br in the horizontal direction corresponds to four times the size (Wc) of the small-sized area Cr in the horizontal direction. On the other hand, the size (Hb, see FIG. 5B) of the medium-sized area Br in the vertical direction corresponds to the size (Hc) of the medium-sized area Br in the vertical direction. That is, the size (Hb) of the medium-sized area Br in the vertical direction is substantially the same as the size (Hc) of the small-sized area Cr in the vertical direction. As shown in FIG. 5A, in each medium-sized area Br, g (specifically, four) small-sized areas Cr are defined in the horizontal direction, and one medium-sized area Br is defined in the vertical direction. Unlike the example shown in FIG. 5A, the size (Hb) of the medium-sized area Br in the vertical direction may correspond to an integer (h) multiple of the size (Hc) of the small-sized area Cr in the vertical direction (h>1).

The medium-sized area Br and the small-sized area Cr are defined in this way, which serves to easily change the layout of the large-sized area Ar and the small-sized area Cr in the monitoring screen. This further facilitates effectively using the monitoring screen M which has a limited area.

The travel data items to be displayed in the travel data areas R1 and R2 may be displayed in any of the areas Ar, Br, and Cr having the size relationship described above.

In the above, the “the size (Wb) of the medium-sized area Br in the horizontal direction” is “Wa/f”. In this regard, “f” is the number of medium-sized areas Br arranged in the horizontal direction in one large-sized area Ar, and is one in FIGS. 5A and 5B. Further, “the size (Hb) of the medium-sized area Br in the vertical direction” is “Ha/e”. This “e” is the number of medium-sized areas Br arranged in the vertical direction in one large-sized area Ar, and is three in the examples in FIGS. 5A and 5B.

In the above, “the size (Wb) of the medium-sized area Br in the horizontal direction corresponds to an integer (g) multiple of the size (Wc) of the small-sized area Cr in the horizontal direction (g>1)” may mean that the first condition and second condition described above are satisfied, for example. That is, the first condition is that the size of g (four in FIG. 5A) small-sized areas Cr arranged in the horizontal direction is equal to or smaller than the size (Wb) of the medium-sized area Br in the horizontal direction. The second condition is that, when (g+1) small-sized areas Cr are arranged in the horizontal direction, the size of the (g+1) small-sized areas Cr in the horizontal direction is larger than the size (Wb) of the medium-sized area Br in the horizontal direction.

Further, “the size (Hb) of the medium-sized area Br in the vertical direction corresponds to the size (Hc) of the small-sized area Cr in the vertical direction” means that the following two conditions are satisfied, for example. The first condition is that the size (Hc) of the small-sized area Cr in the vertical direction is equal to or smaller than the size (Hb) of the medium-sized area Br in the vertical direction. The second condition is that the size (Hb) of the medium-sized area Br in the vertical direction is less than twice the size (Hc) of the small-sized area Cr in the vertical direction.

### [Other Examples of Size and Shape]

The areas Ar, Br, and Cr defined in the travel data area R1 are not limited to the examples shown in FIG. 5A.

For example, the integers p, q, m, n, and e that define the relationship between the sizes of the areas Ar, Br, and Cr are not limited to the examples described above. For example, the size of the large-sized area Ar in the horizontal direction may be twice the size of the small-sized area in the horizontal direction (n=2).

For example, the areas Br and Cr may be longitudinal. That is, the size of the areas Br and Cr in the vertical direction may be larger than the size in the horizontal direction. FIG. 4 shows the medium-sized areas Er81, Er83, and Er83, which are long in the vertical direction, as a variation of the medium-sized area Br. The size (Ha) of the large-sized area Ar in the vertical direction is substantially the same as the size (Hb) of each of the medium-sized areas Er81, Er83, and Er83 in the vertical direction. On the other hand, the size (Wa) of the large-sized area Ar in the horizontal direction corresponds to an integer (i) multiple of the size of each of the medium-sized areas Er81, Er83, and Er83 (i>1).

In the examples shown in FIGS. 4 and 5, three areas Ar, Br, and Cr that are different in size are defined in the travel data area R1. Alternatively, only two types of areas may be defined in the travel data area R1. For example, in the travel data area R1, only two types of the large-sized area Ar and the small-sized area Cr may be defined, only two types of the large-sized area Ar and the medium-sized area Br may be defined, or only two types of the medium-sized area Br and the small-sized area Cr may be defined. In yet another example, four or five areas that are different in size may be defined in the travel data area R1.

### [Adjustment Area]

As shown in FIG. 5A, a plurality of small-sized areas Cr601 to Cr603 and medium-sized areas Br62 are defined in the large-sized area Ar6. In the example shown in FIG. 4, the large-sized area Ar6 defines areas Dr1 and Dr2 in which the travel data is not displayed. In the following, these areas Dr1 and Dr2 are referred to as adjustment areas. The adjustment areas Dr1 and Dr2 are blank areas in which text and graphic are not placed. The adjustment area Dr1 has the same size as the small-sized area Cr, and is defined at the position of the small-sized area Cr604 shown in FIG. 5A. The adjustment area Dr2 has the same size as the medium-sized area Br and corresponds to the medium-sized area Br63 shown in FIG. 5A.

Such adjustment areas Dr1 and Dr2 are used in the monitoring screen M, and this further facilitates changing the layout of the areas Ar, Br, and Cr in the monitoring screen M.

The adjustment areas Dr1 and Dr2 may be provided in a large-sized area Ar that is different from the large-sized area Ar6. Only one of the adjustment areas Dr1 and Dr2 may be defined in the large-sized area Ar.

Unlike the example shown in FIG. 4, the adjustment area Dr1 may be disposed between two small-sized areas Cr. The adjustment area Dr2 may be disposed between the small-sized area Cr and the medium-sized area Br arranged in the vertical direction, or may be disposed between two medium-sized areas Br arranged in the vertical direction.

### [Input Unit in Monitoring Screen]

The travel data area R1 may display one or more input units for receiving an operation of the monitoring person. For example, as shown in FIG. 4, input buttons F1 and F2 may be displayed in the travel data area R1. The input button F1 is used by the monitoring person to stop the vehicle 50A, for example. In the example shown in FIG. 4, “stop” is displayed on the input button F1. The input button F2 is used for restoring the traveling of the vehicle 50A. In the example shown in FIG. 4, “restoration” is displayed on the input button F2.

Upon detecting an operation of the monitoring person to the input buttons F1 and F2, the monitoring terminal 30 (control unit 31) transmits a command (stop or restoration) corresponding to such an operation to the monitoring device 10. The monitoring device 10 (control unit 11) transmits this command to the vehicle 50A. Upon receiving a stop command, for example, the vehicle 50A (control unit 51) stops driving the driving unit 52 of the vehicle 50A. On the other hand, upon receiving a travel restoration command, the vehicle 50A restores the driving unit 52.

As shown in FIG. 4, the input buttons F1 and F2 may have substantially the same size as the medium-sized area Br. The size of the input buttons F1 and F2 is defined in this manner, which serves to easily change the layout of the areas Ar, Br, and Cr and the input buttons F1 and F2 in the monitoring screen.

Unlike the example shown in FIG. 4A, the size of the input buttons F1 and F2 may be substantially the same as the small-sized area Cr. This serves to increase the number of input buttons. As yet another example, the size of the input buttons F1 and F2 may be substantially the same as the large-sized area Ar.

The travel data area R1 may include a text box for entering a numerical value or a word and a list box for selecting a command as an input unit for receiving an operation from the monitoring person. In this case, the input unit may have substantially the same size as the medium-sized area Br, the small-sized area Cr, or the large size region Ar.

[Layout Change when Abnormality is Detected]

The monitoring device 10 (specifically, control unit 11) may determine whether the travel condition of the first vehicle 50A satisfies a predetermined condition based on the travel data of the first vehicle 50A. For example, the monitoring device 10 may determine whether an abnormality has occurred in the first vehicle 50A. If an abnormality occurs in the first vehicle 50A (when the travel condition satisfies a predetermined condition), the first vehicle travel data area R1 may be relatively enlarged in the monitoring screen M. In this case, the second vehicle travel data area R2 (see FIG. 3) may be reduced, or the map area Rm may be reduced. Alternatively, the second vehicle travel data area R2 may be reduced, while the first vehicle travel data area R1 and the map area Rm may be enlarged.

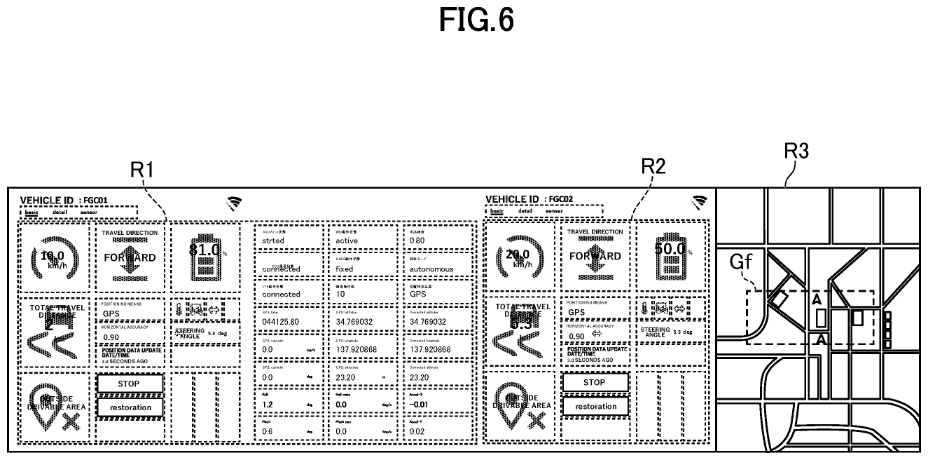

FIG. 6 is a diagram for explaining such a configuration, and shows an example of an enlarged first vehicle travel data area R1. As shown in FIG. 6, the first vehicle travel data area R1 is enlarged in the horizontal direction, for example. In this manner, the monitoring person can understand in detail the travel condition of the first vehicle 50A in which the abnormality has occurred. In the enlarged first vehicle travel data area R1, three types of areas, i.e., the large-sized area Ar, the medium-sized area Br, and the small-sized area Cr may be defined, or two types of areas, i.e., the large-sized area Ar and the medium-sized area Br may be defined.

In the example shown in FIG. 6, the map area Rm is reduced from the normal state (see FIG. 3), and the second vehicle travel data area R2 is the same as the normal state (see FIG. 3). This manner enables the monitoring person to recognize the travel data of the second vehicle 50B even when an abnormality occurs in the first vehicle 50A. In a case where the map area Rm is reduced, the drivable area Gf of the vehicles 50A and 50B are desirably displayed on the map area Rm.

The monitoring device 10 (specifically, control unit 11) may perform the same processing on the second vehicle 50B as the first vehicle 50A. That is, the monitoring device 10 may determine whether the travel condition of the second vehicle 50B satisfies a predetermined condition based on the travel data of the second vehicle 50B. If the travel condition of the second vehicle 50B satisfies the predetermined condition, the second vehicle travel data area R2 may be enlarged and the first vehicle travel data area R1 may be reduced, or the map area Rm may be reduced.

If the travel condition of the first vehicle 50A satisfies the predetermined condition, the layout (including the position and the number) of the areas Ar, Br, and Cr in the first vehicle travel data area R1 may be changed. For example, the travel data item related to the abnormality may be displayed in an area having a size larger than the normal state, and the other travel data items may be displayed in areas having a size smaller than the normal state. For example, if the temperature of the IMU exceeds an appropriate value (if an abnormality occurs in the IMU) while the temperature of the IMU is displayed in the medium-sized area Cr or the small-sized area Cr in the normal state, the temperature of the IMU may be displayed in the large-sized area Br. The other travel data items may be displayed in an area smaller than the normal state. In this case, unlike the case shown in FIG. 6, the travel data area R1 may not be necessarily enlarged.

The same processing may be executed for the second vehicle 50B. That is, the monitoring device 10 may determine whether the travel condition of the second vehicle 50B satisfies the predetermined condition based on the travel data of the second vehicle 50B. When the travel condition of the second vehicle 50B satisfies the predetermined condition, the layout of the areas Ar, Br, and Cr in the second vehicle travel data area R2 may be changed.

If the travel condition of the first vehicle 50A satisfies the predetermined condition (e.g., when an abnormality occurs in the first vehicle 50A), the second vehicle travel data area R2 may be reduced from the original size (e.g., the size shown in FIG. 3), and the first vehicle travel data area R1 may be relatively enlarged. In this method as well, it is possible to focus on the first vehicle 50A in which the abnormality has occurred. When the second vehicle travel data area R2 is reduced from the original size, the layout of the areas Ar, Br, and Cr in the second vehicle travel data area R2 may be changed. For example, the travel data item displayed in the large-sized area Ar may be displayed in the medium-sized area Br or the small-sized area Cr. Further, the travel data item displayed in the medium-sized area Br may be changed to the small-sized area Cr. As yet another example, in a case where the second vehicle travel data area R2 is reduced to a size smaller than the original size, the number of items (travel data) displayed in the area R2 may be reduced. In this manner, if the first vehicle 50 satisfies a predetermined condition, for example, the monitoring person can continue monitoring the second vehicle 50B when an anomaly occurs in the first vehicle 50A.

As described above, the display unit 33 is provided in the monitoring terminal 30 in the travel monitoring system 100, and the monitoring terminal 30 and the monitoring device 10 are connected to each other via the network N. If the travel condition of the first vehicle 50A satisfies the predetermined condition, the monitoring device 10 notifies the monitoring terminal 30 of the occurrence of the abnormality via the network N, and the monitoring terminal 30 executes the processing for changing the layout of the monitoring screen M based on the information received from the monitoring device 10.

Alternatively, if the travel condition of the first vehicle 50A satisfies the predetermined condition, the monitoring device 10 may transmit, to the monitoring terminal 30 via the network N, data for generating the monitoring screen M in which the layout is changed, instead of notifying the monitoring terminal 30 of the abnormality. The data for generating the monitoring screen M is, for example, data that can be analyzed by the browser software installed in the monitoring terminal 30, specifically, data written in HTML, CSS, and JavaScript, for example.

If the travel condition of the first vehicle 50A satisfies the predetermined condition, the monitoring device 10 may stop the first vehicle 50A when the velocity of the first vehicle 50A exceeds a predetermined upper limit, or when the position of the first vehicle 50A is outside the drivable area Gf (FIG. 3), for example, and notify the monitoring terminal 30 of the stop.

### [Processing Executed by Monitoring Device]

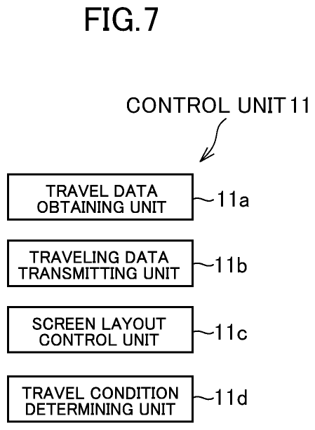

FIG. 7 is a block diagram showing an example of functions of the monitoring device 10. As shown in FIG. 7, the monitoring device 10 functionally includes a travel data obtaining unit 11a, a traveling data transmitting unit 11b, and a screen layout control unit 11c. These functions are implemented when the calculation unit 11A of the monitoring device 10 executes a program stored in the storage unit 11B.

The travel data obtaining unit 11a receives the travel data of the vehicles 50A and 50B at predetermined time intervals. The travel data obtaining unit 11a may store the received travel data in the storage unit 11B.

The travel data transmitting unit 11b transmits the travel data of the vehicles 50A and 50B to the monitoring terminal 30 at predetermined time intervals. The travel data transmitting unit 11b transmits the travel data to the monitoring terminal 30 in response to a request from the monitoring terminal 30 at the predetermined time intervals (polling). Alternatively, after a connection between the travel data transmitting unit 11b and the monitoring 30 terminal is established, the travel data transmitting unit 11b may transmit the travel data to the monitoring terminal 30 regardless of a request at the predetermined time intervals. Such transmission may be performed by WebSocket protocols, for example.

### [Screen Layout Control Unit]

The screen layout control unit 11c generates monitoring screen control information for displaying the monitoring screen described with reference to FIGS. 3 to 6 on the display unit 33 of the monitoring terminal 30. The monitoring screen control information can be analyzed by browser software, for example, and is written in HTML, CSS, and JavaScript, for example. The monitoring screen control information may include image data of a type mark displayed in the large-sized area Ar and the small-sized area Cr.

The screen layout control unit 11c may obtain an instruction to change the layout of the monitoring screen from the monitoring person or the operator of the travel monitoring system 100. The screen layout control unit 11c may define the layout (relative position) of the travel data items to be displayed in the travel data areas R1 and R2 and the layout of the areas Ar, Br, and Cr for displaying the travel data items based on the layout change instruction. In other words, the screen layout control unit 11c may generate the monitoring screen control information such that the layout is provided according to the layout change instruction.

For example, if the vehicle speed is defined to be displayed in the medium-sized area Br in the initial monitoring screen control information, the screen layout control unit 11c may generate new monitoring screen control information so that the vehicle speed is displayed in the large-sized area Ar in accordance with the layout change instruction.

Such processing of the screen layout control unit 11c enables displaying a monitoring screen suitable for the needs of the monitoring person. Further, even if the needs of the monitoring person change, it is possible to display a monitoring screen suitable for the new needs.

One layout change instruction may be reflected in both the first vehicle travel data area R1 and the second vehicle travel data area R2. That is, the first vehicle travel data area R1 and the second vehicle travel data area R2 may be formed in the monitoring terminal 30 based on the monitoring screen control information generated from one layout change instruction. This allows the monitoring person or the operator of the travel monitoring system 100 to simplify the work for changing the layout.

### [Layout Change Instruction Table]

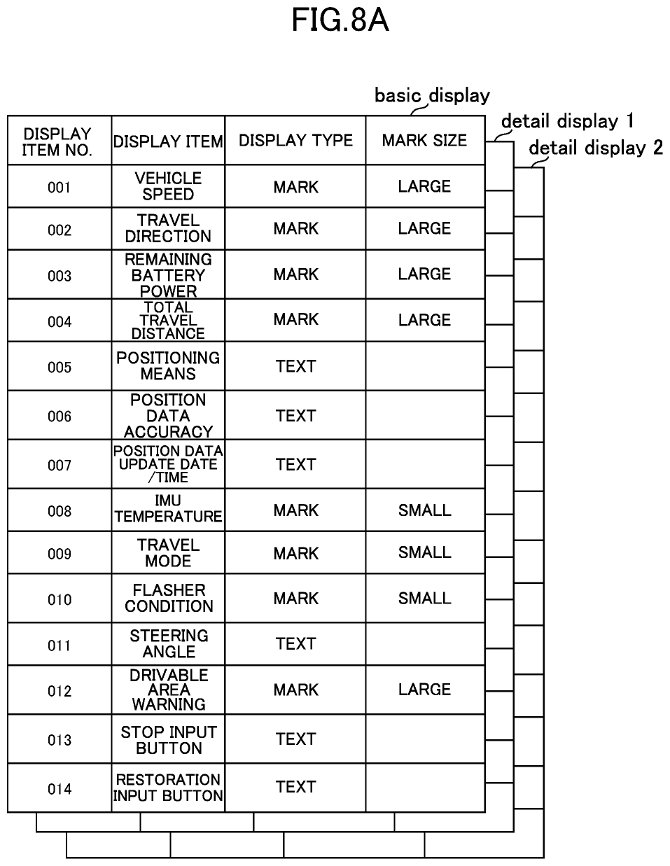

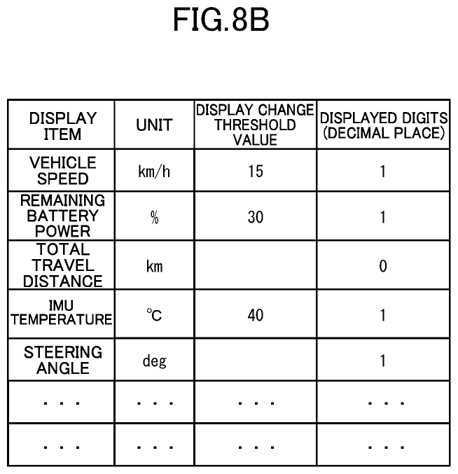

FIG. 8A is a diagram illustrating an example of a layout change instruction. The layout change instruction shown in FIG. 8A is an instruction for generating the travel data area R1 shown in FIG. 4. As shown in FIG. 8A, the layout change instruction has a table format, for example. In the layout change instruction table, the travel data item, which is a display item, is associated with a display type (mark/text), for example. The travel data may be associated with the size (large/small) of the type mark in the layout change instruction table.

In the example shown in FIG. 8A, a display item having a display type “mark” and a mark size “large” is travel data displayed in the large-sized area Ar, for example. A display item having a display type “text” is travel data displayed in the medium-sized area Br, for example. A display item having a display type “mark” and a mark size “small” is travel data displayed in the small-sized area Cr, for example.

In the example shown in FIG. 8A, the displayed items include “vehicle speed”, “travel direction”, “remaining battery power”, and “total travel distance”, for example. The display type of “mark” is defined for “vehicle speed”, “travel direction”, “remaining battery power”, and “total travel distance.” The display type of “text” is defined for “positioning means”, “position data accuracy”, and “position data obtaining date and time.” The mark size “large” is associated with “vehicle speed”, “travel direction”, “remaining battery power”, “travel distance”, and “drivable area warning”, and the mark size “small” is associated with “IMU temperature”, “travel mode”, and “flasher condition.”

The input unit may be defined as a display item in the layout change instruction table. In the example shown in FIG. 8A, a “stop input button” and a “restoration input button” are defined as display items.

The travel data items are displayed in the travel data areas R1 and R2 in the order defined in the layout change instruction table. In the example shown in FIG. 8A, a plurality of travel data items are arranged in the column direction. The travel data items are displayed in the travel data areas R1 and R2 in the order described in the layout change instruction table. In the example shown in FIG. 8A, the “vehicle speed”, “travel direction”, “remaining battery power”, and “total travel distance” as the travel data items are arranged in this order. As such, as shown in FIG. 4, these travel data items are arranged in the order of left to right in the upper row, left to right in the middle row, and left to right in the lower row of the travel data areas R1 and R2. The travel data items displayed in the medium-sized area Br (e.g., “positioning means” and “position data accuracy”) are arranged from top to bottom in the large-sized area Ar in the order recorded in the layout change instruction table. The travel data items displayed in the small-sized area Cr (e.g., “IMU temperature”, “travel mode”, “flasher condition”) are arranged in the order recorded in the layout change instruction table from left to right in the upper row, from left to right in the middle row, and from left to right in the lower row of the large-sized area Ar.

In other words, the layout change instruction table includes information about the size and position of the area for displaying the travel data items in the travel data areas R1 and R2. More specifically, the order of the travel data items recorded in the layout change instruction table corresponds to the order displayed in the travel data areas R1 and R2.

In the layout change instruction table, display items (travel data/input unit) can be added or deleted, display types can be changed between “mark” and “text”, and mark sizes can be changed between “large” and “small”. This enables changing the size and the position of the area in which the travel data is displayed. Such layout changes may be allowed for all of the travel data items, or only for some of the travel data items. For example, any display type (mark/text) and mark size (large/small) may be selectable for the vehicle speed and the remaining battery power. On the other hand, for example, only the text may be selectable as the display type in the area in which the position information (latitude, longitude, altitude) is displayed.

As described above, in the monitoring screen M proposed in the present disclosure, the size of the large-sized area Ar is an integer multiple of the small-sized area Cr, the size of the large-sized area Ar is an integer multiple of the medium-sized area Br, and the size of the medium-sized area Br is an integer multiple of the small-sized area Cr. For this reason, the layout of the travel data areas R1 and R2 can be changed by using a simple table as shown in FIG. 8A.

As described referring to FIG. 4, the travel data areas R1 and R2 can be selected from a plurality of display options. In the example shown in FIG. 4, the display of the travel data area R1 can be selected from “basic”, “detail 1”, and “detail 2”. In this case, as shown in FIG. 8A, a layout change instruction table may be generated for each of “basic”, “detail 1”, and “detail 2”.

The layout change instruction is not limited to the table format shown in FIG. 8A. For example, a plurality of options may be prepared in advance as the layout (relative position) of the areas Ar, Br, and Cr in the travel data areas R1 and R2. The monitoring person or the operator of the travel monitoring system 100 may be able to select one of the options. In this case, such a selection may be a layout change instruction.

### [Generation of Monitoring Screen Control Information]

The screen layout control unit 11c generates monitoring screen control information for the monitoring terminal 30 to display the monitoring screen based on the layout change instruction. In the monitoring screen control information, the travel data items displayed in the travel data areas R1 and R2 and the sizes and positions of the areas for displaying the travel data items are defined. As described above, such monitoring screen control information is written in HTML, CSS, and JavaScript, for example.

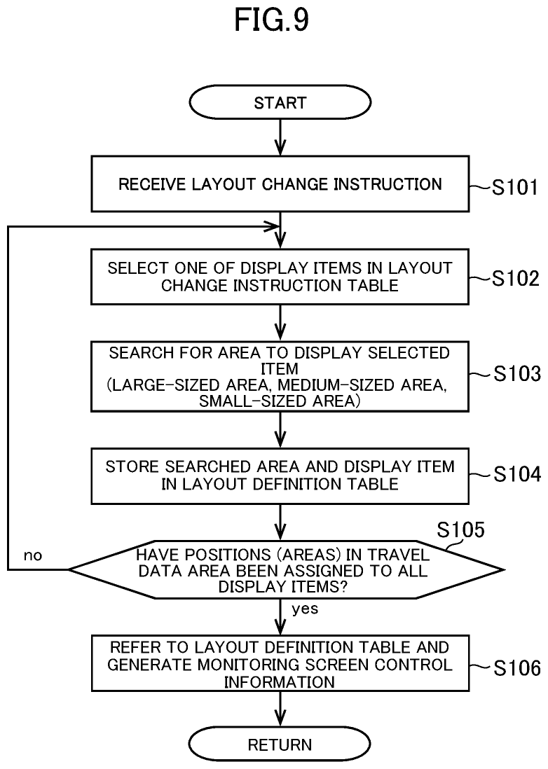

FIG. 9 is a flow chart showing an example of processing executed by the screen layout control unit 11c for generating monitoring screen control information. In the layout change instruction table shown in FIG. 8A, travel data items to be displayed in the travel data areas R1 and R2 are listed. As described above, the travel data items (e.g., vehicle speed, travel direction, remaining battery power) are arranged in this order in the travel data areas R1 and R2. The processing shown in FIG. 9 is an example of such processing. The processing described herein is merely an example of the processing executed by the screen layout control unit 11c.

The monitoring device 10 receives a layout change instruction table from the monitoring terminal 30 (S101). The screen layout control unit 11c selects one of the display items in the layout change instruction table received from the monitoring terminal 30 (S102).

For example, the screen layout control unit 11c may first select the display item (in FIG. 8A, vehicle speed, mark, large) at the top of the layout change instruction table. After the processing in S104 to be described later, the screen layout control unit 11c may select the second display item (in FIG. 8A, travel direction, mark, large) of the layout change instruction table. In other words, every time the processing reaches S101, the screen layout control unit 11c sequentially selects the display items of the layout change instruction table in the order from the top.

As described above referring to FIG. 5A, a plurality of large-sized areas Ar1, Ar2, . . . , a plurality of medium-sized areas Br11, Br12, . . . , and a plurality of small-sized areas Cr101, Cr102, . . . are defined in the travel data areas R1 and R2. The screen layout control unit 11c searches for an area in which the display item selected in S102 is displayed from among these areas (S103).

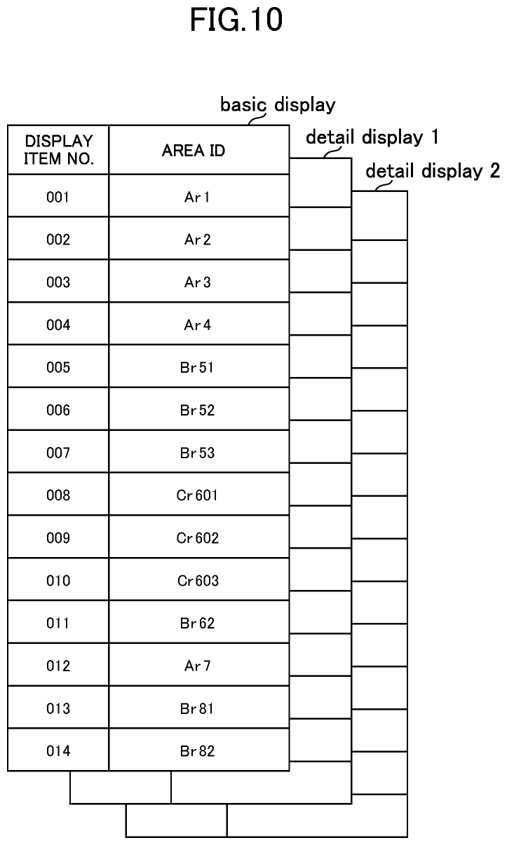

For example, the screen layout control unit 11c searches for an area in which the display item can be placed based on the sizes (display type and mark size) of the respective display items specified in the layout change instruction table and the sizes of the areas (Ar1, Ar2, Br11, Br12, Cr101, Ar102,). The screen layout control unit 11c stores the searched areas Ar1, Ar2, Br11, Br12, Cr101, Ar102,) in the table (S104) (in the following, this table is referred to as a layout definition table). FIG. 10 is a diagram showing an example of a layout definition table. As shown in FIG. 10, in the layout definition table, the display item numbers recorded in the layout change instruction table shown in FIG. 8A are associated with the positions (areas Ar, Br, Cr) where the display items are displayed, for example.

An example of the processing executed in S103 and S104 will be described referring to the travel data area R1 in FIG. 4, the travel data area R1 in FIG. 5A, and the layout change instruction table in FIG. 8A.

When selecting the display item (number 001, vehicle speed, mark, large) at the top in the layout change instruction table in FIG. 8A, the screen layout control unit 11c is allowed to display the vehicle speed in the large-sized area Ar1 (FIGS. 4 and 5A) at the upper left of the travel data areas R1 and R2. As such, the screen layout control unit 11c assigns the large-sized area Ar1 to such a display item (number 001, vehicle speed, mark, large). Accordingly, as shown in FIG. 10, the number “001” of the display item is associated with the large-sized area Ar1. When the second display item (number 002, travel direction, mark, large) of the layout change instruction table is selected, such a display item is allowed to be displayed in the adjacent large-sized area Ar2 (FIGS. 4 and 5A). As such, the screen layout control unit 11c assigns the large-sized area Ar2 to such a displayed item (number 002, travel direction, mark, large). Accordingly, as shown in FIG. 10, the number “002” of the display items is associated with the large-sized area Ar2. The same processing is executed on the subsequent display items (number 003, remaining battery power, mark, large) (number 004, total travel distance, mark, large).

When the display item (number 005, positioning means, text) in the layout change instruction table shown in FIG. 8A is selected in S101, the position measuring means “GPS” is allowed to be displayed in the medium-sized area Br51 (FIGS. 4 and 5A) of the travel data areas R1 and R2. As such, the screen layout control unit 11c assigns the medium-sized area Br51 to such a displayed item. Accordingly, as shown in FIG. 10, the number “005” of the display item is associated with the medium-sized area Br51. The next display item (number 006, position data accuracy, text) is allowed to be displayed in the medium-sized area Br52 therebelow (FIGS. 4 and 5A). Accordingly, as shown in FIG. 10, the number “006” of the display item is associated with the medium-sized area Br52. The same processing is executed on the subsequent display item (number 007, position data update date and time, text).

The display items (number 008, IMU temperature, mark, small) (number 009, driving mode, mark, small) (number 010, flasher condition, mark, small) in the layout change instruction table shown in FIG. 8A can be respectively displayed in the small-sized areas Cr601, Cr602, and Cr603 (FIGS. 4 and 5A). As such, the screen layout control unit 11c respectively assigns the small-sized areas Cr601, Cr602, and Cr603 to these display items, and records such assignment in the layout definition table of FIG. 10.

The display item (number 011, steering angle, text) in the layout change instruction table shown in FIG. 8A is to be displayed in the medium-sized area Br, and thus cannot be displayed in the small-sized area Cr604 (FIG. 5A) adjacent to the small-sized area Cr603. As such, the screen layout control unit 11c sets the small-sized area Cr604 as a blank adjustment area Dr1 (FIG. 4), and assigns the subsequent medium-sized area Br62 to the display item (number 011, steering angle, text). The screen layout control unit 11c records such assignment in the layout definition table in FIG. 10.

The medium-sized area Br63 (FIG. 5A) is located below the medium-sized area Br62, but the display item (number 012, drivable area warning, mark, large) in the layout change instruction table is to be displayed in the large-sized area Ar, and thus cannot be displayed in the medium-sized area Br63. As such, the screen layout control unit 11c sets the medium-sized area Br63 as a blank adjustment area Dr2 (FIG. 4), assigns the subsequent large-sized area Ar7 (FIGS. 4 and 5A) to the display item (number 012, drivable area warning, mark, large), and records such assignment in the layout definition table in FIG. 10.

The display item number 013 (stop input button, text) and the display item number 014 (travel restoration input button, text) in the layout change instruction table can be respectively displayed in the medium-sized areas Br81 and Br82. As such, the screen layout control unit 11c respectively assigns the medium-sized areas Br81 and Br82 to these display items, and records such assignment in the layout definition table of FIG. 10.

As described above, the screen layout control unit 11c searches for an area in which each display item can be displayed based on the sizes of the display items specified in the layout change instruction table (i.e., display type and mark size) and the sizes of the areas (Ar1, Ar2 . . . Br11, Br12 . . . Cr101, Ar102 . . . ) defined in the travel data areas R1 and R2. The screen layout control unit 11c assigns the areas (Ar1, Ar2 . . . Br11, Br12 . . . Cr101, Ar102 . . . ) defined in the travel data areas R1 and R2 to the respective display items in the order defined in the layout change instruction table.

As described above, in the monitoring screen M proposed in the present disclosure, the size of the large-sized area Ar is an integer multiple of the small-sized area Cr, the size of the large-sized area Ar is an integer multiple of the medium-sized area Br, and the size of the medium-sized area Br is an integer multiple of the small-sized area Cr. For this reason, the areas (Ar1, Ar2 . . . Br11, Br12 . . . Cr101, Ar102 . . . ) can be assigned to the respective display items with the use of the simple table as shown in FIG. 8A.

The screen layout control unit 11c determines whether the areas Ar, Br, and Cr in the travel data areas R1 and R2 have been assigned to all the display items recorded in the layout change instruction table (S105). If there is a display item to which an area has not been assigned, the screen layout control unit 11c returns to S102 and executes the subsequent processing. If all of the display items are assigned with areas, the screen layout control unit 11c refers to the layout definition table shown in FIG. 10 and generates monitoring screen control information (S106). In other words, the screen layout control unit 11c generates the monitoring screen control information so that a plurality of travel data items are displayed in the order defined in the layout change instruction.

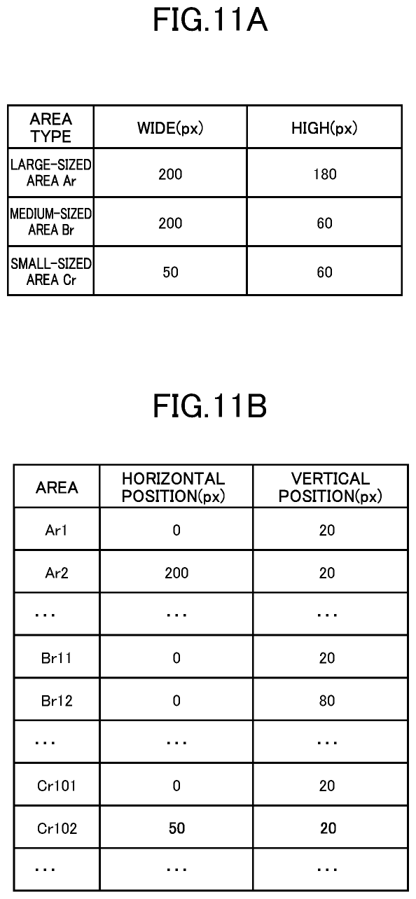

In S105, the screen layout control unit 11c may use a table that defines the respective positions of the areas (Ar1, Ar2 . . . , Br11, Br12 . . . , Cr101, Ar102) and a table that defines the sizes of the respective areas to generate monitoring screen control information. FIG. 11A is an example of a table that defines a size (pixel value) of each area, and FIG. 11B is an example of a table that defines a position (pixel value) of each area (AAr1, Ar2 . . . , Br11, Br12 . . . , Cr101, Ar102 . . . ). These tables are stored in the storage unit 11B in advance. The screen layout control unit 11c refers to these tables and the layout definition table (FIG. 10), thereby generating the monitoring screen control information readable by the browser software of the monitoring terminal 30. The example of the processing executed by the screen layout control unit 11c is as described above.

The screen layout control unit 11c may generate monitoring screen control information for generating the monitoring screen when an abnormality occurs, which has been described with reference to FIG. 6, in the same manner as the processing described with reference to FIGS. 8A and 9.

The monitoring person or the operator of the travel monitoring system 100 may determine and change a display format of the travel data. For example, the monitoring person may determine or change the unit and the number of decimal places of the travel data. FIG. 8B is a diagram showing an example of a table for setting a display format. In the following, this table is referred to as a “display format instruction table”. In the display format instruction table, for example, the unit and the number of decimal places may be associated with each of the travel data items, such as the vehicle speed and the total travel distance. In the example shown in FIG. 8B, “km/h” and “1” are respectively associated with the unit and the numbers of decimal places for “vehicle speed”. “1” means that the number of decimal places to be displayed is one.

If the travel data exceeds the threshold value, the display format may be changed. For example, if the vehicle speed exceeds the threshold value, the color of the vehicle speed, the number of decimal places to be displayed, and the type mark indicating the vehicle speed may be changed in the monitoring screen M. In this case, a threshold value for changing the display format of the travel data may be determined in the display format instruction table. In the example shown in FIG. 8B, “15” is associated with “vehicle speed” as a threshold value. In this case, when the vehicle speed of the vehicle 50 exceeds 15 km/h, the color of the vehicle speed or the type mark indicating the vehicle speed may be changed in the monitoring screen M. The monitoring person may adjust such a threshold value in view of the type of the vehicle 50 and the drivable area.

Upon receiving the layout change instruction table in FIG. 8A and the display format instruction table in FIG. 8B, the screen layout control unit 11c generates monitoring screen control information based on these tables for the monitoring terminal 30 to display the monitoring screen.

The vehicles 50 may transmit data (CAN data) in a format compliant with CAN (controller area network) to the monitoring device 10. This data may be converted to a format suitable for display and then displayed. For example, the vehicle 50 may transmit the travel direction of the vehicle with a binary value of “0” or “1” to the monitoring device 10. In this case, “0” may be displayed as “forward” and “1” may be displayed as “backward”, for example. Such conversion processing may be executed in the monitoring device 10 or in the monitoring terminal 30. If the conversion processing is executed in the monitoring terminal 30, information for such conversion processing (e.g., Javascript code) may be written in the monitoring screen control information generated by the monitoring device 10.

The travel data transmitted from the monitoring device 10 to the monitoring terminal 30 may be a part of data (e.g., CAN data) transmitted from the vehicle 50 to the monitoring device 10. For example, if the CAN data represents a numerical value of five decimal places, the travel data transmitted from the monitoring device 10 to the monitoring terminal 30 may have one decimal place. In this case, the monitoring device 10 may store the CAN data in the storage unit 11B as it is (in the previous example, a numerical value of five decimal places), and transmit only a part of CAN data as the travel data to the monitoring terminal 30.

### [Travel Condition Determining Unit]

Travel condition determining unit 11d determines whether the travel condition of the vehicles 50A and 50B satisfies a predetermined condition based on the travel data of the vehicles 50A and 50B. More specifically, the travel condition determining unit 11d determines whether an abnormality has occurred in the vehicles 50A and 50B. If an abnormality has occurred in the vehicles 50A or 50B (when the travel condition satisfies a predetermined condition), the travel condition determining unit 11d notifies the monitoring terminal 30 of the abnormality. The travel condition determining unit 11d may determine whether the vehicles 50A and 50B are located within the drivable area Gf based on the position data of the vehicles 50A and 50B. If the vehicles 50A or 50B are outside the drivable area Gf, the travel condition determining unit 11d may notify the monitoring terminal 30 of such information.

### [Processing Executed by Monitoring Terminal]

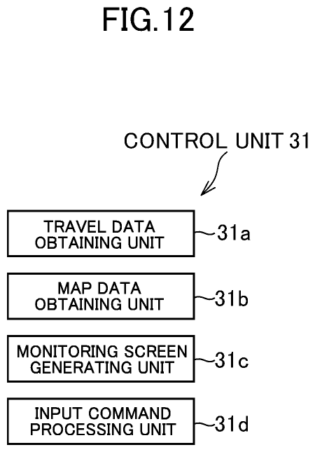

FIG. 12 is a block diagram showing an example of functions of the monitoring terminal 30. As shown in FIG. 12, the monitoring terminal 30 functionally includes a travel data obtaining unit 31a, a map data obtaining unit 31b, a monitoring screen generating unit 31c, and an input command processing unit 31d.

In an example of the travel monitoring system 100, these functions (31a to 31d) are implemented by the control unit 31 of the monitoring terminal 30 executing the processing in accordance with the monitoring screen control information received from the monitoring device 10 via the browser software.

### [Travel Data Obtaining Unit]

The travel data obtaining unit 31a receives the travel data of the vehicles 50A and 50B from the monitoring device 10 at predetermined time intervals.

### [Map Data Obtaining Unit]

The map data obtaining unit 31b obtains map data of an area around the area in which the vehicles 50A and 50B are traveling (e.g., drivable area Gf, see FIG. 3) via the network N. The monitoring terminal 30 may be connected to a server device that provides the map data via the network N. In this case, the map data obtaining unit 31b requests the server device to send the map data of the area in which the vehicles 50A and 50B are traveling, and receives the map data as a response from the server device. Alternatively, the monitoring device 10 may have map data. In this case, the map data obtaining unit 31b may request the monitoring device 10 for sending the map data and receive the map data as a response from the monitoring device 10.

### [Monitoring Screen Generating Unit]

The monitoring screen generating unit 31c generates the monitoring screen M in accordance with the monitoring screen control information received from the monitoring device 10. In other words, the travel data of the vehicles 50A and 50B received by the travel data obtaining unit 31a is displayed in the area (Ar, Br, Cr) specified by the monitoring screen control information. As described above, the monitoring terminal 30 (travel data obtaining unit 31a) receives travel data at predetermined time intervals. The monitoring screen generating unit 31c updates the travel data displayed in the travel data areas R1 and R2 at predetermined time intervals. The frequency of receiving the travel data may be different from the frequency of updating the travel data displayed on the monitoring screen M.

The monitoring screen generating unit 31c displays the map data obtained by the map data obtaining unit 31b in the map area Rm, and also displays the marks N1 and N2 (see FIG. 3) indicating the positions of the vehicles 50A and 50B in the map area Rm.

As described above, only the mark that indicates the type of the travel data is displayed in the small-sized area Cr, and the text, which is travel data, is not displayed. Upon detecting that the monitoring person has selected the mark of the small-sized area Cr, the monitoring screen generating unit 31c may display the travel data item corresponding to the mark on the monitoring screen M. For example, when the monitoring person places the pointer, which is displayed on the monitoring screen M, on the mark of the small-sized area Cr using the input unit 34 (e.g., mouse pointer), the monitoring screen generating unit 31c may display the travel data item corresponding to the mark on the monitoring screen M. Referring to FIG. 4, when the mark of the IMU temperature displayed in the small-sized area Cr601 is selected, the monitoring screen generating unit 31c may display the temperature of the IMU on the monitoring screen M.

As described above, when an abnormality is detected based on the travel data, the monitoring device 10 (travel condition determining unit 11d) transmits information (abnormality notification) indicating the abnormality of the vehicles 50A and 50B to the monitoring terminal 30. When the monitoring terminal 30 receives the abnormality notification, as described referring to FIG. 6, the monitoring screen generating unit 31c enlarges the travel data area R1 (or R2) of the vehicle 50A (or 50B) in which the abnormality has occurred, the monitoring screen generating unit 31c reduces the travel data area R2 (or R1) of the vehicle 50B (or 50A) in which no abnormality is detected, or reduces the map area Rm. Alternatively, the monitoring screen generating unit 31c may enlarge the map area Rm while reducing the travel data area R2 (or R1) of the vehicle 50B (or 50A) in which no abnormality is detected. When the monitoring terminal 30 receives the abnormality notification from the monitoring device 10, the monitoring screen generating unit 31c may change the display form (e.g., color) of the travel data related to the abnormality. For example, when the monitoring terminal 30 receives the abnormality notification indicating that the vehicles 50A and 50B are out of the drivable area Gf, the “drivable area warning” may be turned on in the travel data area R1 or may change the display color thereof.

### [Input Command Processing Unit]

As described above, the input buttons F1 and F2 are displayed on the monitoring screen M. The input command processing unit 31d determines whether the monitoring person has selected the input buttons F1 and F2. For example, the input command processing unit 31d determines whether the position of the pointer displayed on the monitoring screen M is placed on the input buttons F1 and F2 by utilizing the input unit 34 (see FIG. 1) and whether a predetermined operation (e.g., click) is performed through the input unit 34. Upon detecting that the monitoring person has selected the input buttons F1 and F2, the input command processing unit 31d transmits a command associated with the input buttons F1 and F2 to the monitoring device 10. The monitoring device 10 transmits the command to the vehicles 50A and 50B.

### [Operation of Entire System]

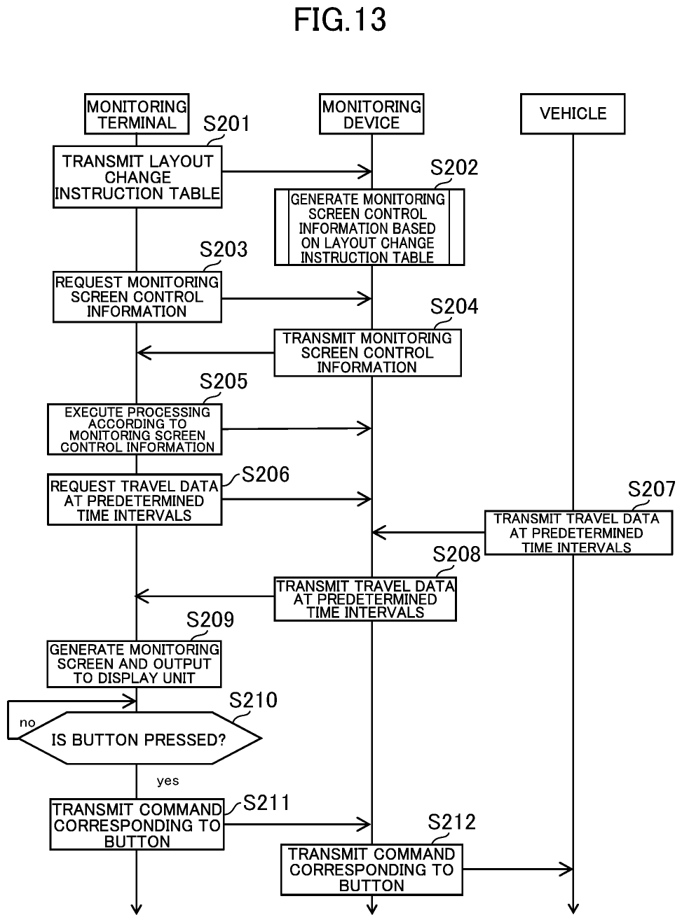

FIG. 13 is a flow chart showing an example of the processing executed by the monitoring device 10, the monitoring terminal 30, and the vehicle 50.

The monitoring terminal 30 first transmits a layout change instruction table (see FIG. 8A) to the monitoring device 10 via the monitoring terminal 30 (S201). The monitoring device 10 (screen layout control unit 11c) generates monitoring screen control information based on the layout change instruction table (S202). As described above, the monitoring screen control information is for defining the layout of the positions (areas Ar, Br, Cr) to display the travel data of the vehicles 50A and 50B. The processing in S202 has been described referring to FIG. 9, for example.

The monitoring terminal 30 is connected to the monitoring device 10 via the network N, and transmits a request for monitoring screen control information to the monitoring device 10 (S203). The monitoring device 10 transmits the monitoring screen control information generated in S202 to the monitoring terminal 30 as a response (S204). Upon receiving the monitoring screen control information, the monitoring terminal 30 (monitoring screen generating unit 31c) executes the processing according to the monitoring screen control information using the browser software (S205). The monitoring terminal 30 (travel data obtaining unit 31a) then requests the monitoring device 10 for the travel data of the vehicles 50A and 50B (S206). The monitoring terminal 30 (map data obtaining unit 31b) requests the server device or the monitoring device 10 for the map data of an area around the drivable area Gf of the vehicles 50A and 50B. The vehicles 50A and 50B transmit the travel data to the monitoring device 10 at predetermined time intervals (S207). The monitoring device 10 transmits the travel data to the monitoring terminal 30 at predetermined time intervals (S208).

The monitoring terminal 30 (monitoring screen generating unit 31c) uses the browser software to execute the processing according to the monitoring screen control information, thereby generating a monitoring screen M on which the travel data is displayed and outputting the generated monitoring screen M to the display unit 33 (S209). The monitoring terminal 30 (monitoring screen generating unit 31c) updates the travel data displayed on the monitoring screen at predetermined time intervals.

The monitoring terminal 30 (input command processing unit 31d) determines whether the input buttons F1 and F2 in the monitoring screen M are selected through the input unit 34 (S210). Upon detecting that the input buttons F1 and F2 have been selected, the monitoring terminal 30 (input command processing unit 31d) transmits a command corresponding to the input buttons F1 and F2 to the monitoring device 10 (S211). The monitoring device 10 transmits the command received from the monitoring terminal 30 to the vehicles 50A and 50B (S212).

### CONCLUSION

(1) As described above, a travel monitoring system 100 includes a communication unit 13 that receives a plurality of travel data items of a first vehicle 50A and a control unit 11 that controls a display device 33 to display a monitoring screen M indicating the plurality of travel data items. The control unit 11 reserves a plurality of large-sized areas Ar and a plurality of medium-sized areas Br or a plurality of small-sized areas Cr in the monitoring screen M. The control unit 11 displays the travel data item (e.g., vehicle speed) in the large-sized area Ar. The control unit 11 displays a guidance (mark) indicating the travel data item or a type of the travel data item in the medium-sized area Br or the small-sized area Cr. A size of the large-sized area Ar in one of a horizontal direction and a vertical direction is an integer (n) multiple of a size of the small-sized area Cr (n>1). A size of the large-sized area Ar in one of a horizontal direction and a vertical direction is an integer (e) multiple of a size of the medium-sized area Br (e>1). The large-sized area Ar, the medium-sized area Br, and the small-sized area Cr are defined in this manner, which serves to easily change a layout of the large-sized area Ar, the medium-sized area Br, and the small-sized area Cr in the monitoring screen M. This enables easily and effectively using the monitoring screen M having a limited area.
(2) and (4) The size of the large-sized area Ar in the vertical direction is an integer (m) multiple of the size of the small-sized area Cr in the vertical direction (m>1), and the size of the large-sized area Ar in the horizontal direction is an integer (n) multiple of the size of the small-sized area Cr in the horizontal direction (n>1). This serves to easily change the layout of the large-sized area Ar and the small-sized area Cr in the monitoring screen M.
(3) and (5) The size of the large-sized area Ar in the vertical direction is an integer (e) multiple of the size of the medium-sized area Br in the vertical direction (e>1), and the size of the large-sized area Ar in the horizontal direction corresponds to the size of the medium-sized area Br. This serves to easily change the layout of the large-sized area Ar and the medium-sized area Br in the monitoring screen.
(6) The control unit 11 reserves three types of areas, i.e., a large-sized area Ar, a medium-sized area Br, and a small-sized area Cr in the monitoring screen M. This further facilitates effectively using the monitoring screen M having a limited area.
(7) The control unit 11 displays text and graphics (type mark) related to the travel data in the large-sized area Ar. The control unit 11 displays only text related to the travel data in the medium-sized area Br, and displays only graphics related to a guidance indicating the type of the travel data in the small-sized area Cr. This further facilitates effectively using the monitoring screen M having a limited area.
(8) The control unit reserves a first vehicle travel data area R1 and a second vehicle travel data area R2 in the monitoring screen, where the plurality of travel data items of the first vehicle 50A are displayed in the first vehicle travel data area R1 and the plurality of travel data items of the second vehicle 50B are displayed in the second vehicle travel data area R2. Each of the first vehicle travel data area R1 and the second vehicle travel data area R2 includes a large-sized area Ar and a medium-sized area Br or a small-sized area Cr. This system enables to simultaneously monitor a plurality of vehicles.
(9) The control unit 11 may change a layout of areas Ar, Br, and Cr in each of the first vehicle travel data area R1 and the second vehicle travel data area R2 in accordance with a layout change instruction. This enables to simplify the work of changing the layout of the large-sized area Ar and the areas Br and Cr in the plurality of travel data areas R1 and R2.
(10) The control unit 11 determines whether a travel condition of the first vehicle 50A satisfies a predetermined condition based on the travel data items, and, if the first vehicle 50A satisfies the predetermined condition, relatively enlarges the first vehicle travel data area R1. This allows a monitoring person to appropriately recognize a case when an abnormality occurs in the travel condition of the first vehicle 50A. If the first vehicle 50A satisfies the predetermined condition, the second vehicle travel data area R2 may maintain the original size (e.g. the size in FIG. 3), while the first vehicle travel data area R1 may be enlarged from the original size (e.g. the size in FIG. 3). Alternatively, the second vehicle travel data area R2 may be reduced from the original size (e.g., the size in FIG. 3), and the first vehicle travel data area R1 may be relatively enlarged. In either way, it is possible to focus on the first vehicle 50A in which the anomaly has occurred.
(11) The control unit 11 obtains a layout change instruction and changes the layout of the areas Ar, Br, and Cr in the monitoring screen M based on the layout change instruction. This enables changing the layout of the areas Ar, Br, and Cr in the monitoring screen M in accordance with the needs of the monitoring person.
(12) The layout change instruction includes information about the size and position of the area for displaying the travel data items in the travel data areas R1 and R2. This increases a flexibility in layout in the travel data areas R1 and R2 as compared with a case where the layout of the travel data areas R1 and R2 can be selected from only a plurality of options.
(13) The control unit 11 displays the first travel data item in the large-sized area Ar in a first display condition (e.g., “basic”), and displays the first travel data item in the medium-sized area Br in a second display condition (e.g., “detail 1”). This enables the first travel data item to be displayed in both the large-sized area Ar and the medium-sized area Br, thereby increasing a flexibility in layout in the monitoring screen M.
(14) The control unit 11 determines whether a travel condition of the first vehicle 50A satisfies a predetermined condition, and if the travel condition of the first vehicle 50A satisfies the predetermined condition, changes a layout of the plurality of large-sized areas Ar and the area Br and Cr. This configuration helps, when an abnormality occurs in the vehicle, appropriately present the travel data related to the abnormality to the monitoring person.
(15) The control unit 11 reserves a medium-sized area Br62 and small-sized areas Cr601, Cr602, and Cr603 in an area having a size corresponding to the large-sized area Ar (area Ar6 in FIGS. 4 and 5A). The control unit 11 reserves adjustment areas Dr1 and Dr2, in which no travel data item is displayed, in the large-sized area Ar6. The use of the adjustment areas Dr1 and Dr2 further facilitates changing the layout of the large-sized area Ar and the areas Br and Cr in the monitoring screen M.
(16) The control unit 11 displays input units F1 and F2 (see FIG. 4) that have a size corresponding to the large-sized area Ar and the medium-sized area Br and receives an operation of the monitoring person. Upon detecting an operation on the input units F1 and F2, the control unit 11 may transmit a command according to the operation to the first vehicle 50A.

### Modifications

The travel monitoring system proposed in the present disclosure is not limited to the travel monitoring system 100 described above. For example, the monitoring terminal 30 may include dedicated software installed therein without using browser software. The dedicated software may implement the functions of the travel data obtaining unit 31a and the monitoring screen generating unit 31c, for example.

In still another example, the monitoring device 10 may include a display unit, and such a display unit may display the monitoring screen M.

The invention claimed is:

1. A travel monitoring system of a vehicle, comprising:
a communication unit that receives a plurality of travel data items of a first vehicle; and
a control unit that controls a display device to display a monitoring screen indicating the plurality of travel data items, wherein
the control unit reserves a plurality of first sized areas and a plurality of second sized areas in the monitoring screen,
each of the plurality of first sized areas has a first size in a first direction, which is one of a vertical direction and a horizontal direction, and has a second size in a second direction, which is the other of the vertical direction and the horizontal direction,
each of the plurality of second sized areas has a third size in the first direction and has a fourth size in the second direction,
the first size corresponds to an integer multiple of the third size, the integer being greater than one, and
the control unit displays a first travel data item in one of the plurality of first sized areas, the first travel data item being one of the plurality of travel data items, and displays a second travel data item or a guidance indicating a type of the second travel data item in one of the plurality of second sized areas, the second travel data item being another one of the plurality of travel data items.

2. The travel monitoring system of the vehicle according to claim 1, wherein
the second size corresponds to an integer multiple of the fourth size, the integer being greater than one.

3. The travel monitoring system of the vehicle according to claim 1, wherein
the second size corresponds to the fourth size.

4. The travel monitoring system of the vehicle according to claim 3, wherein
the first direction is a vertical direction, and
the second direction is a horizontal direction.

5. The travel monitoring system of the vehicle according to claim 3, wherein
the first direction is a horizontal direction, and
the second direction is a vertical direction.

6. The travel monitoring system of the vehicle according to claim 1, wherein
the control unit reserves the plurality of first sized areas, the plurality of second sized areas, and a plurality of third sized areas in the monitoring screen,
each of the plurality of third sized areas has a fifth size in the first direction and a sixth size in the second direction, and
the third size corresponds to an integer multiple of the fifth size and/or the fourth size corresponds to an integer multiple of the sixth size, the integer being greater than one.

7. The travel monitoring system of the vehicle according to claim 1, wherein
the control unit displays text and a graphic relating to the first travel data item in the one of the plurality of first sized areas, and
the control unit displays one of the text and the graphic relating to the guidance in the one of the second sized areas, the guidance representing the second travel data item or a type of the second travel data item.

8. The travel monitoring system of the vehicle according to claim 1, wherein
the control unit reserves a first vehicle travel data area and a second vehicle travel data area in the monitoring screen, the plurality of travel data items of the first vehicle being displayed in the first vehicle travel data area, the plurality of travel data items of a second vehicle being displayed in the second vehicle travel data area, and
each of the first vehicle travel data area and the second vehicle travel data area includes the plurality of first sized areas and the plurality of second sized areas.

9. The travel monitoring system of the vehicle according to claim 8, wherein
the control unit changes relative positions of the plurality of first sized areas and the plurality of second sized areas in each of the first vehicle travel data area and the second vehicle travel data area in accordance with a layout change instruction.

10. The travel monitoring system of the vehicle according to claim 8, wherein
the control unit determines whether a travel condition of the first vehicle satisfies a predetermined condition based on the plurality of travel data items, and, if the first vehicle satisfies the predetermined condition, enlarges the first vehicle travel data area.

11. The travel monitoring system of the vehicle according to claim 1, wherein
the control unit obtains a layout change instruction and changes relative positions of the plurality of first sized areas and the plurality of second sized areas in the monitoring screen based on the layout change instruction.

12. The travel monitoring system of the vehicle according to claim 10, wherein
the layout change instruction includes information on a size and a position of an area in which each travel data item is displayed.

13. The travel monitoring system of the vehicle according to claim 1, wherein
the control unit displays the first travel data item in the one of the plurality of first sized areas in a first display condition, and displays the first travel data item in one of the plurality of second sized areas in a second display condition.

14. The travel monitoring system of the vehicle according to claim 1, wherein
the control unit determines whether a travel condition of the first vehicle satisfies a predetermined condition, and if the travel condition of the first vehicle satisfies the predetermined condition, changes a layout of the plurality of first sized areas and the plurality of second sized areas.

15. The travel monitoring system of the vehicle according to claim 1, wherein
the control unit reserves at least one of the plurality of second sized areas in an area having a size corresponding to the first sized area, and
the control unit reserves a layout adjustment area in the area in which the at least one of the second sized areas is reserved, the layout adjustment area being an area in which the plurality of travel data items are not displayed.

16. The travel monitoring system of the vehicle according to claim 1, wherein
the control unit displays an input unit that has a size corresponding to the first sized area or the second sized area and receives an operation of a monitoring person, and
upon detecting an operation on the input unit, the control unit transmits a command according to the operation to the first vehicle.

17. A travel monitoring method of a vehicle, comprising:
receiving a plurality of travel data items of a first vehicle; and
controlling a display device to display a monitoring screen indicating the plurality of travel data items, wherein
a first travel data item is displayed in one of the plurality of first sized areas, the first travel data item being one of the plurality of travel data items, and a second travel data item or a guidance indicating a type of the second travel data item is displayed in one of the plurality of second sized areas, the second travel data item being another one of the plurality of travel data items,
each of the plurality of first sized areas has a first size in a first direction, which is one of a vertical direction and a horizontal direction, and has a second size in a second direction, which is the other of the vertical direction and the horizontal direction,
each of the plurality of second sized areas has a third size in the first direction and has a fourth size in the second direction, and
the first size corresponds to an integer multiple of the third size, the integer being greater than one.

18. A non-transitory information storage medium storing a travel monitoring program of a vehicle, the travel monitoring program causes a computer to function as:
a communication unit that receives a plurality of travel data items of a first vehicle; and
a control unit that controls a display device to display a monitoring screen indicating the plurality of travel data items, wherein
the control unit reserves a plurality of first sized areas and a plurality of second sized areas in the monitoring screen,
the control unit displays a first travel data item in one of the plurality of first sized areas, the first travel data item being one of the plurality of travel data items, and displays a second travel data item or a guidance indicating a type of the second travel data item in one of the plurality of second sized areas, the second travel data item being another one of the plurality of travel data items,
each of the plurality of first sized areas has a first size in a first direction, which is one of a vertical direction and a horizontal direction, and has a second size in a second direction, which is the other of the vertical direction and the horizontal direction,
each of the plurality of second sized areas has a third size in the first direction and has a fourth size in the second direction,
the first size corresponds to an integer multiple of the third size, the integer being greater than one.
